(19) United States
(12) Patent Application Publication
(10) Pub. No.: US 2014/0285550 A1
(43) Pub. Date: Sep. 25, 2014

(54) FUNCTIONAL LIQUID EJECTION APPARATUS, FUNCTIONAL LIQUID EJECTION METHOD AND IMPRINTING SYSTEM

(71) Applicant: FUJIFILM CORPORATION, Tokyo (JP)

(72) Inventors: Kenichi KODAMA, Kanagawa (JP); Kunihiko KODAMA, Shizuoka (JP); Tadashi OMATSU, Kanagawa (JP)

(73) Assignee: FUJIFILM CORPORATION, Tokyo (JP)

(21) Appl. No.: 14/034,339

(22) Filed: Sep. 23, 2013

Related U.S. Application Data
(63) Continuation of application No. PCT/JP2012/058504, filed on Mar. 23, 2012.

(30) Foreign Application Priority Data
Mar. 25, 2011 (JP) 2011-068531

(51) Int. Cl. B41J 2/045

(52) U.S. Cl. CPC B41J 2/04501
USPC 347/10

(57) ABSTRACT

A nozzle ejects a functional liquid having a viscosity of not less than 5 millipascal·second and not more than 20 millipascal·second, onto a substrate. The functional liquid inside a pressure chamber connected to the nozzle is pressurized. A drive voltage having a pull waveform element which causes the pressure chamber to expand from a steady state and a push waveform element which causes the expanded pressure chamber to contract, is generated with a relationship between a slope γ₁ representing voltage change per unit time in the pull waveform element, the viscosity η of the functional liquid, a resonance period T_{c} of the head, and a slope γ₂ representing voltage change per unit time in the push waveform element satisfying (2/T_{c})≦γ₁≦(η/10) and γ₂≦γ₁.

### TECHNICAL FIELD

The present invention relates to a functional liquid ejection apparatus, a functional liquid ejection method, and an imprinting system, and more particularly to a liquid application technique for applying functional liquid to a medium such as a substrate by an inkjet method.

### BACKGROUND ART

With the development of increasingly fine semiconductor integrated circuits and higher levels of integration in recent years, nanoprint lithography is known as technology for forming a fine structure on a substrate in which a fine pattern is transferred to a substrate (resist) by applying a resist (UV-curable resin) onto the substrate, curing the resist by irradiation of ultraviolet light in a state where a mold formed with a desired topographical pattern to be transferred is pressed against the resist, and separating the mold from the resist on the substrate.

A system which employs an inkjet method has been proposed as a mode for depositing imprinting material (resist liquid) on a substrate. An inkjet method requires stabilization of the viscosity of the resist liquid, because the ejection state changes depending on the viscosity of the resist liquid. Furthermore, resist liquid has higher viscosity than ink which is used for graphics, and therefore it is difficult to achieve a stable ejection state.

Patent Literature 1 (“PTL 1”) discloses technology for an ejection method which pressurizes liquid inside a pressure chamber by deforming a pressure chamber using a piezo element in which ink having high viscosity of 6 to 20 millipascal-second (mPa·s) is ejected in a stable fashion by making the slope of a drive waveform for causing a pressure chamber having a reference volume to expand before ejection larger than the slope of the drive waveform for causing the pressure chamber to expand to the reference volume from a contracted state after ejection.

Patent Literature 2 (“PTL 2”) discloses a liquid ejection apparatus which prevents the occurrence of mist when ink of high-viscosity, such as UV ink (ultraviolet-curable ink), is ejected by contracting a pressure chamber after expanding the pressure chamber, through applying a drive voltage having an expansion element including a first expansion element and a second expansion element having different voltage change rates, and a contraction element including a first contraction element and a second contraction element having different voltage change rates.

### SUMMARY OF INVENTION

### Technical Problem

However, the technology disclosed in Patent Literature 1 is effective in systems where, when the inks of a plurality of types are used, a drive waveform can be set for each type of inks, but it is difficult to respond to changes in viscosity as a result of temperature change, evaporation of solvent with the passage of time after ejection, and different ink batches.

For example, there may be a lack of ejection stability, and mist may occur due to change in the ink viscosity with temperature change for instance.

Furthermore, with the technology disclosed in Patent Literature 2, there is a concern about decline in the robustness of ejection with respect to mist which adheres to the vicinity of the nozzles, depending on the relationship between the first expansion element and the second expansion element.

### Solution to Problem

The present invention has been contrived in view of these circumstances, an object thereof being to provide a functional liquid ejection apparatus, a functional liquid ejection method and an imprinting system for achieving desirable liquid ejection which ensures robust when a functional liquid of high viscosity is ejected continuously at high frequency using an inkjet method.

One aspect of the invention is directed to a functional liquid ejection apparatus comprising: a liquid ejection head which includes a nozzle ejecting a functional liquid having a viscosity of not less than 5 millipascal·second and not more than 20 millipascal·second, onto a substrate, and a piezoelectric element for pressurizing the functional liquid inside a pressure chamber connected to the nozzle; a relative movement means which causes relative movement between the substrate and the liquid ejection head; a drive voltage generating means which generates a drive voltage having a pull waveform element which causes the pressure chamber to expand from a steady state and a push waveform element which causes the expanded pressure chamber to contract, with a relationship between a slope γ₁ representing voltage change per unit time in the pull waveform element when a maximum voltage is defined as 1, the viscosity η of the functional liquid, and a resonance period T_{c} of the liquid ejection head satisfying the following expression: (2/T_{c})≦γ₁≦(η/10), and a relationship between a slope γ₂ representing voltage change per unit time in the push waveform element when a maximum voltage is defined as 1, and the slope γ₁ of the pull waveform element, satisfying the following expression: γ₂≦γ₁; and an ejection head drive means which applies the generated drive voltage to the piezoelectric element so as to cause the functional liquid to be ejected from the liquid ejection head onto the substrate.

Another aspect of the invention is directed to a functional liquid ejection method comprising: a relative movement step of causing relative movement between a liquid ejection head and a substrate, the liquid ejection head including a nozzle and a piezoelectric element, the nozzle ejecting a functional liquid having a viscosity of not less than 5 millipascal·second and not more than 20 millipascal·second onto a substrate, the piezoelectric element pressurizing the functional liquid inside the pressure chamber connected to the nozzle; a drive voltage generating step of generating a drive voltage having a pull waveform element which causes the pressure chamber to expand from a steady state and a push waveform element which causes the expanded pressure chamber to contract, wherein a relationship between a slope γ₁ representing voltage change per unit time when a maximum voltage in the pull waveform element is defined as 1, the viscosity η of the functional liquid, and a resonance period T_{c} of the liquid ejection head satisfies the following expression: (2/T_{c})≦γ₁≦(η/10), and a relationship between a slope γ₂ representing voltage change per unit time in the push waveform element when a maximum voltage is defined as 1, and the slope γ₁ of the pull waveform element, satisfies the following expression: γ₂≦γ₁; and a functional liquid application step of applying the generated drive voltage to the piezoelectric element so as to cause the functional liquid to be ejected from the liquid ejection head onto the substrate.

Another aspect of the invention is directed to an imprinting system comprising: a liquid ejection head which includes a nozzle ejecting a functional liquid having a viscosity of not less than 5 millipascal·second and not more than 20 millipascal·second, onto a substrate, and a piezoelectric element for pressurizing the functional liquid inside a pressure chamber connected to the nozzle; a relative movement means which causes relative movement between the substrate and the liquid ejection head; a drive voltage generating means which generates a drive voltage having a pull waveform element which causes the pressure chamber to expand from a steady state and a push waveform element which causes the expanded pressure chamber to contract, with a relationship between a slope γ₁ representing voltage change per unit time in the pull waveform element when a maximum voltage is defined as 1, the viscosity η of the functional liquid, and a resonance period T_{c} of the liquid ejection head satisfying the following expression: (2/T_{c})≦γ₁≦(η/10), and a relationship between a slope γ₂ representing voltage change per unit time in the push waveform element when a maximum voltage is defined as 1, and the slope γ₁ of the pull waveform element satisfying: γ₂≦γ₁; an ejection head drive means which applies the generated drive voltage to the piezoelectric element so as to cause the functional liquid to be ejected from the liquid ejection head onto the substrate; and a transfer means which transfers a projection-recess pattern of a mold in which the projection-recess pattern is formed, onto a surface of the substrate onto which the functional liquid has been applied.

### Advantageous Effects of Invention

According to the present invention, in a liquid application apparatus which ejects a functional liquid of high viscosity of not less than 5 mPa·s and not more than 20 mPa·s by pull-push driving of a piezoelectric element using a drive waveform having a pull waveform element and a push waveform element, by using a drive voltage having a slope γ₁ of the pull waveform element whereby the relationship between the resonance period T_{c} of the liquid ejection head and the viscosity η of the functional liquid satisfies (2/T_{c})≦γ₁≦(η/10), and having a slope γ₂ of the push waveform element which satisfies γ₂≦γ₁, it is possible to perform stable continuous ejection at high frequency, even if there is change in the viscosity of the functional liquid due to the evaporation of solvent or temperature change, or the like.

### BRIEF DESCRIPTION OF DRAWINGS

FIGS. 1A to 1F are diagrams for describing steps of a nano-imprinting system relating to an embodiment of the present invention.

FIG. 2 is a general schematic drawing of a nano-imprinting system relating to an embodiment of the present invention.

FIG. 3 is a schematic drawing showing an approximate structure of the photo-curable resin liquid application unit shown in FIG. 2.

FIG. 4 is a plan view diagram showing an example of a structure of the inkjet head shown in FIG. 3.

FIG. 5 is a diagram showing a further mode of a photo-curable resin liquid application unit in FIG. 3.

FIGS. 6A and 6B are plan view diagrams showing an example of a structure of the inkjet head shown in FIG. 5.

FIG. 7 is a cross-sectional diagram showing a structure of the inkjet head shown in FIGS. 3 and 5.

FIG. 8 is a block diagram showing an approximate configuration of a control system of the nano-imprinting system shown in FIG. 2.

FIG. 9 is a block diagram showing an example of the composition of the head driver shown in FIG. 8.

FIGS. 10A and 10B are illustrative diagrams of a drive voltage generated by the head driver shown in FIG. 8.

FIG. 11 is an illustrative diagram of evaluation results of the slope of the pull waveform shown in FIGS. 10A and 10B.

FIGS. 12A to 12C are illustrative diagrams showing a schematic view of the behavior of a meniscus based on difference in the slope of the pull waveform shown in FIGS. 10A and 10B.

(a) to (f) of FIG. 13 are illustrative diagrams showing change in the shape of an ejected droplet due to variation in the slope of the pull waveform.

FIG. 14 is an illustrative diagram of evaluation results of the slope of the push waveform shown in FIGS. 10A and 10B.

(a) to (e) of FIG. 15 are illustrative diagrams showing change in the shape of an ejected droplet due to variation in the slope of the push waveform.

FIG. 16 is an illustrative diagram showing a relationship between a slope of a pull waveform and a slope of a push waveform.

FIG. 17 is an illustrative diagram of a nozzle shape.

FIG. 18 is an illustrative diagram showing the relationship between the taper angle and the acoustic inertance.

FIG. 19 is a diagram for describing a further nozzle shape.

### DESCRIPTION OF EMBODIMENTS

### [Explanation of Nanoimprint Method]

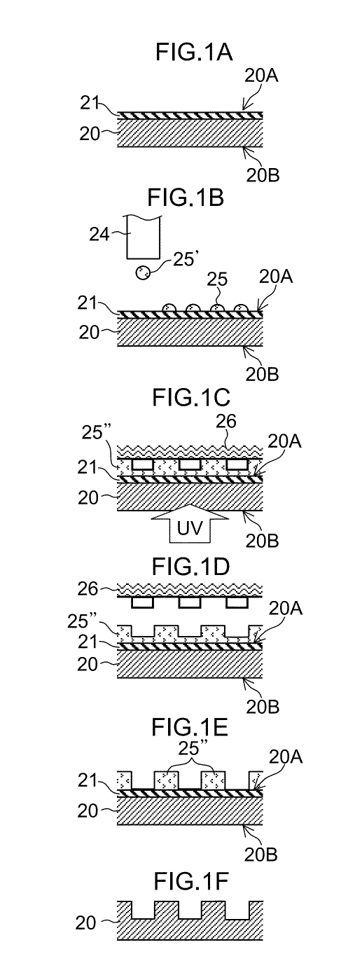

First, a nanoimprint method according to an embodiment of the present invention will be explained with reference to FIGS. 1A to 1F by tracing the process sequence thereof. With the nanoimprint method shown in the present example, a protrusion-depression pattern formed on a mold (for example, a Si mold) is transferred to a photocurable resin film obtained by curing a photocurable resin liquid (a functional liquid such as a resist liquid) formed on a substrate (quartz substrate or the like), and a micropattern is formed on the substrate by using the photocurable resin film as a mask pattern.

First, a quartz substrate 20 (referred to hereinbelow simply as “substrate”) shown in FIG. 1A is prepared. A hard mask layer 21 is formed on a front surface 20A of the substrate 20 shown in FIG. 1A, and a micropattern is formed on the front surface 20A. The substrate 20 has a predetermined transmissivity allowing the substrate to transmit light such as UV radiation and desirably, may have a thickness of equal to or greater than 0.3 millimeters (mm). Such light transmissivity makes it possible to conduct exposure from a rear surface 20B of the substrate 20.

Examples of substrates suitable as the substrate 20 used when a Si mold is used include substrates covered on the surface thereof with a silane coupling agent, substrates on which a metal layer constituted by Cr, W, Ti, Ni, Ag, Pt, Au and the like is stacked, substrates on which a metal oxide layer such as CrO₂, WO₂, or TiO₂ is stacked, and such laminates covered on the surface thereof with a silane coupling agent.

Thus, a laminate (covered material) such as the aforementioned metal film or metal oxide film is used as the hard mask layer 21 shown in FIG. 1A. Where the thickness of the laminate exceeds 30 nanometers (nm), light transmissivity decreases and curing defects easily occur in the photocurable resin. Therefore, the laminate thickness is equal to or less than 30 nm, preferably equal to or less than 20 nm.

The “predetermined transmissivity” as referred to herein ensures that the light coming from the rear surface 20B of the substrate 20 will exit from the front surface 20A and that the functional liquid (for example, the liquid including the photocurable resin that is denoted by the reference numeral 25 in FIG. 1C) formed on the surface will be sufficiently cured. For example, the transmittance of light with a wavelength of equal to or greater than 200 nm that comes from the rear surface may be desirably equal to or greater than 5%.

The structure of the substrate 20 may be a monolayer structure or a laminated structure. In addition to quartz, such materials as silicon, nickel, aluminum, glass, and resins can be used as appropriate for the substrate 20. These materials may be used individually or may be used as appropriate in combinations of two or more thereof.

When a material other than quartz is used for the substrate 20, quartz is used for the material of the mold (labeled “26” in FIGS. 1C and 1D) and the exposure is performed from the mold side.

The thickness of substrate 20 is preferably equal to or greater than 0.05 mm, more preferably equal to or greater than 0.1 mm. Where the thickness of the substrate 20 is less than 0.05 mm, there is a possibility that a deflection may occur on the substrate side and a uniform contact state may not be obtained when the mold and the body where the pattern is to be formed are brought into intimate contact. Further, with the object of avoiding fractures during handling or under pressure during imprinting, it is even more preferred that the thickness of the substrate 20 be equal to or greater than 0.3 mm.

A plurality of droplets 25′ inducing a photocurable resin are discretely ejected from an inkjet head 24 onto the front surface 20A of the substrate 20 (FIG. 1B: ejecting step). The expression “droplets discretely ejected” herein means that a plurality of droplets (denoted by the reference numeral 25) have landed with a predetermined spacing, without coming into contact with other droplets that have landed at the adjacent ejecting positions on the substrate 20 (this issue will be discussed below in greater detail).

In the ejection step shown in FIG. 1B, in order to eject a photo-curable resin liquid having a viscosity of not less than 5 mPa·s (centipoises) and not more than 20 mPa·s, continuously in a stable fashion from the inkjet head 24, the slope γ of the drive voltage for actuating the inkjet head 24 is specified on the basis of the resonance period T_{c} of the inkjet head and the viscosity η of the photo-curable resin liquid.

More specifically, in an inkjet method, by keeping the viscosity of the ejected liquid as uniform as possible, it is possible to perform stable continuous ejection at high speed, but with liquids employed in an inkjet method, there is liable to be change in the viscosity due to change in the ambient temperature, or fluctuation in viscosity between different lots (differences in the amount of solvent in each lot), and it is difficult to improve robustness.

In the present embodiment, the slope (slew rate) of the drive voltage is decided on the basis of the resonance period T_{c} of the inkjet head and the viscosity η of the photo-curable resin liquid, and therefore the stability of continuous ejection is not impaired by external disturbances, such as temperature change. The details of the drive voltage are described below.

Furthermore, the ejection volume, the ejection density and the ejection (flight) speed of the photo-curable resin liquid 25 are set (adjusted) in advance. For example, the ejection volume and the ejection density are adjusted so as to be relatively large in a region where recess portions of a topographical (projecting-recess) pattern of a mold (indicated by reference numeral 26 in FIG. 1C) have a large spatial volume, and so as to be relatively small in a region where the recess portions have a small spatial volume or a region where there are no recess portions. After adjustment, the photo-curable resin liquid 25 is disposed on the substrate 20 in accordance with a prescribed droplet ejection arrangement (pattern).

After the droplet ejection step shown in FIG. 1B, the photo-curable resin liquid 25 on the substrate 20 is spread by pressing the topographical pattern surface of the mold 26 in which a topographical (projecting-recess) pattern is formed, against the front surface 20A of the substrate 20 with a prescribed pressing force, whereby a photo-curable resin layer 25″ is formed by the joining together of a plurality of photo-curable resin liquids 25 which have been spread (FIG. 1C: photo-curable resin layer forming step).

In the photocurable resin layer formation step, after the atmosphere between the mold 26 and the substrate 20 has been depressurized or evacuated, the amount of residual gas can be reduced by pressing the mold 26 against the substrate 20.

However, under high-vacuum atmosphere, the uncured photocurable resin layer 25″ volatilizes and a uniform film thickness can be difficult to maintain. Accordingly, the amount of residual gas may be desirably reduced by substituting the atmosphere between the mold 26 and the substrate 20 with helium (He) atmosphere or He reduced-pressure the atmosphere. Since He permeates the quartz substrate 20, the amount of the residual gas (He) that has been taken in is gradually reduced. Since a certain time is required for the He permeation, the He reduced-pressure atmosphere is preferred.

The pressing force of the mold 26 is within a range of from 100 kilo Pascal (kPa) to 10 mega Pascal (MPa) (a range of not less than 100 kPa and not greater than 10 MPa). A relatively high pressing force enhances the resin flow, also enhances the compression of the residual gas, dissolution of the residual gas in the photocurable resin and the He permeation in the substrate 20, and leads to the improved tact time.

However, where the pressing force is too high, foreign matter may enter between the mold 26 and the substrate 20 when the mold 26 comes into contact with the substrate 20, and the mold 26 and the substrate 20 may be damaged. For this reason, the pressing force of the mold 26 is set within the above-mentioned range.

The range of the pressing force of the mold 26 is more preferably from 100 kPa to 5 MPa (not less than 100 kPa and not greater than 5 MPa), even more preferably from 100 kPa to 1 MPa (not less than 100 kPa and not greater than 1 MPa). The reason why the pressing force is set to a value equal to or higher than 100 kPa is because the space between the mold 26 and the substrate 20 be filled with the photocurable resin liquid 25 and the space between the mold 26 and the substrate 20 be pressurized under the atmospheric pressure (about 101 kPa) when imprinting is performed under the atmosphere.

Irradiation with UV radiation is then performed from the rear surface 20B of the substrate 20, the photocurable resin liquid 25″ is exposed, and the photocurable resin film 25″ is cured (FIG. 1C: the photocurable resin film curing step). In the present example, a photocurable system is illustrated in which the photocurable resin layer 25″ is cured by light (UV radiation), but another curing system may be also used. For example, a thermocurable resin film may be formed by using a liquid including a thermocurable resin and the thermocurable resin film may be cured by heating.

After the photocurable resin layer 25″ has been sufficiently cured, the mold 26 is separated from the photocurable resin layer 25″ (FIG. 1D: separation step). Any method that is unlikely to damage the pattern of the photocurable resin layer 25″ may be used for separating the mold 26. Thus, the mold may be separated gradually from the edge portion of the substrate 20, or the separation may be performed, while applying a pressure from a side of the mold 26, so as to reduce the force applied to the photocurable resin layer 25″ on a boundary line at which the mold 26 is separated from the photocurable resin layer 25″ (pressurization separation method).

Further, a method (heating-assisted separation) can be also used in which the vicinity of the photocurable resin layer 25″ is heated, an adhesive force between the photocurable resin layer 25″ and the mold 26 at the interface of the mold 26 and the photocurable resin layer 25″ is reduced, the Young's modulus of the photocurable resin layer 25 is reduced, resistance to embrittlement is improved, and fracture caused by deformation is inhibited. A composite method in which the above-mentioned methods are combined as appropriate may be also used.

According to the steps shown in FIGS. 1A to 1D, the protrusion-depression pattern formed on the mold 26 is transferred to the photocurable resin layer 25″ formed on the front surface 20A of the substrate 20. In the photocurable resin film 25″ formed on the substrate 20, the ejection arrangement density of the photocurable resin liquid 25 that will form the photocurable resin layer 25″ is optimized according to physical properties of the liquid including the photocurable resin and the protrusion-depression state of the mold 26. Therefore, the uniformity of residual thickness is improved, and the desirable protrusion-depression pattern that is free of defects can be formed.

A fine pattern is then formed on the substrate 20 (or a metal film covering the substrate 20) by using the photocurable resin layer 25″ as a mask.

Where the protrusion-depression pattern of the photocurable resin layer 25″ located on the substrate 20 is transferred, the photocurable resin liquid 25 located inside the depressions of the photocurable resin layer 25″ is removed, and the front surface 20A of the substrate 20 or the metal film or the like formed on the front surface 20A is exposed (FIG. 1E: ashing step).

Where dry etching is further performed by using the photocurable resin layer 25″ as a mask (FIG. 1F: etching step) and the photocurable resin layer 25″ is removed, a fine pattern corresponding to the protrusion-depression pattern formed on the photocurable resin layer 25″ is formed on the substrate 20.

Where a metal film or a metal oxide film is formed on the front surface 20A of the substrate 20, the predetermined pattern is formed on the metal film or metal oxide film.

Any method may be used for dry etching, provided that this method can use the photocurable resin film as a mask. Specific examples of suitable methods include ion milling method, reactive ion etching (RIE), and sputter etching. Among these methods, ion milling method and reactive ion etching (RIE) are especially preferred.

The ion milling method is also called ion beam etching. In this method, ions are generated by introducing an inactive gas such as Ar into an ion source. The generated ions are accelerated when passing through a grid and collided with the sample substrate, thereby etching the substrate.

An ion source of a Kaufman type, a high-frequency type, an electron collision type, a duoplasmatron type, a Freeman type, and an ECR (electron cyclotron resonance) type can be used. Ar gas can be used as the process gas in ion beam etching, and fluorine-containing gas or chlorine-containing gas can be used as the etchant of RIE.

As described hereinabove, the fine pattern using the nanoimprint method shown in the present example is formed by using as a mask the photocurable resin layer 25″ onto which the protrusion-depression pattern of the mold 26 has been transferred, and performing dry etching by using the mask that is free from defects caused by thickness unevenness of the remaining film and residual gasses. Therefore, the fine patter can be formed on the substrate 20 with high accuracy and good yield.

By using the above-described nanoimprint method, it is possible to fabricate a quartz substrate mold for use in the nanoimprint method.

### [Description of Nano-Imprinting System]

Next, a nano-imprinting system (nano-imprinting apparatus) for achieving the nano-imprinting method described above will be explained. In the following description, parts which are the same as or similar to the preceding description are labeled with the same reference numerals and further explanation thereof is omitted here.

### [General Composition]

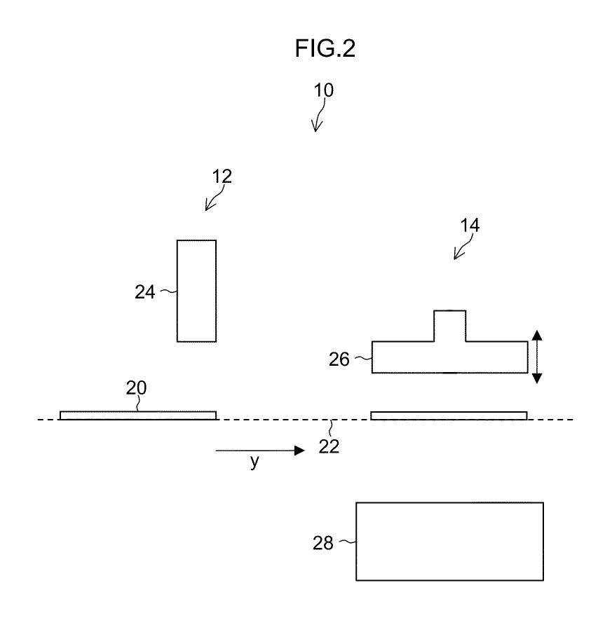

FIG. 2 is a general schematic drawing of a nano-imprinting system relating to an embodiment of the present invention. The nano-imprinting system 10 shown in FIG. 2 comprises a photo-curable resin liquid application unit 12 which applies a photo-curable resin liquid (resist liquid) in the form of fine liquid droplets onto a substrate 20 having light transmitting properties, such as quartz glass, a pattern transfer unit 14 which transfers a desired pattern to the photo-curable resin liquid applied to the substrate 20, and a conveyance unit 22 which conveys the substrate 20.

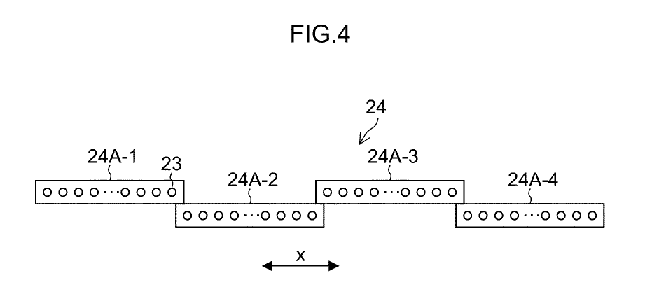

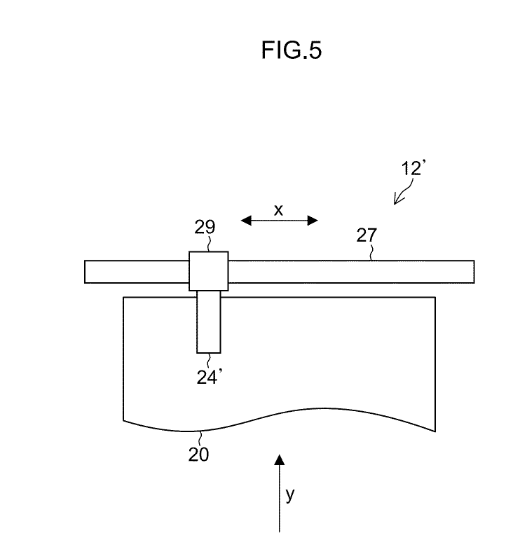

The photo-curable resin liquid ejection unit 12 comprises an inkjet head 24 in which a plurality of nozzles are formed (not shown in FIG. 2; indicated by reference numeral 23 in FIG. 4), and applies photo-curable resin liquid 25 to a surface of a substrate 20 (photo-curable resin liquid deposition surface) by ejecting the photo-curable resin liquid 25 in the form of fine droplets, from the nozzles.

The pattern transfer unit 14 comprises a mold 26 in which a desired topographical pattern to be transferred to the photo-curable resin liquid 25 on the substrate 20 is formed, and an ultraviolet irradiation apparatus 28 which radiates ultraviolet light, and performs pattern transfer onto the photo-curable resin liquid 25 on the substrate 20 (photo-curable resin layer 25″), by carrying out ultraviolet irradiation from the rear side of the substrate 20 (the surface on the opposite side to the front surface against which the mold 26 is pressed), in a state where the mold 26 is pressed against the front surface of the substrate 20 where the photo-curable resin liquid 25 is disposed, and thereby curing the photo-curable resin liquid 25 on the substrate 20.

Silicon is used for the mold 26. Furthermore, by composing the substrate 20 from a light transmitting material which can transmit ultraviolet light irradiated from the ultraviolet irradiation apparatus 28, when ultraviolet light is irradiated from the ultraviolet irradiation apparatus 28 which is disposed below the substrate 20 (the opposite side to the mold 26), the ultraviolet is irradiated onto the photo-curable resin liquid 25 on the substrate 20 without being shielded by the substrate 20, and the photo-curable resin liquid 25 can be cured.

The light transmitting material may employ glass, quartz, or the like, for example.

The mold 26 is composed movably in the vertical direction in FIG. 2 (the direction indicated by the double arrow); the mold 26 is moved downward while maintaining a state where the pattern forming surface of the mold 26 is substantially parallel to the surface of the substrate 20, and contacts the whole surface of the substrate 20 virtually simultaneously, thereby performing pattern transfer.

Although not shown in FIG. 2, the mold 26 is made of a light transmitting material and a mode is possible in which ultraviolet light is irradiated from the front surface side of the substrate 20 (the mold side).

The conveyance unit 22 includes a conveyance means which secures and conveys a substrate 20, such as a conveyance stage, for instance, and conveys the substrate 20 in a direction from the photo-curable liquid application unit 12 toward the pattern transfer unit 14 (also called the “y direction” below), while holding the substrate 20 on the surface of the conveyance device.

As a concrete example of the conveyance means, it is possible to adopt a combination of a linear motor and an air slider, or a combination of a linear motor and an LM guide, or the like. It is possible to adopt a composition in which either the photo-curable liquid application unit 12 or the pattern transfer unit 14, or both, are moved, instead of moving the substrate 20.

### [Description of Photo-Curable Resin Liquid Ejection Unit]

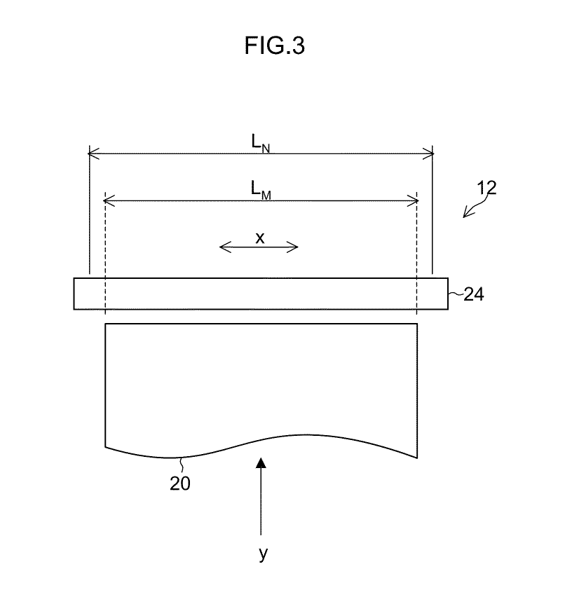

FIG. 3 is a schematic drawing showing an approximate composition of the photo-curable liquid ejection unit 12. The inkjet head 24 shown in FIG. 3 is a long full-line head having a structure in which a plurality of nozzles (not illustrated in FIG. 3; indicated by reference numeral 23 in FIG. 4) are arranged through a length L_{N} which exceeds the maximum width L_{M} of the substrate 20, in an x direction which is perpendicular to the y direction (the conveyance direction of the substrate 20).

In liquid ejection using a full line-type inkjet head 24, it is possible to dispose the photo-curable resin liquid 25 (see FIGS. 1B to 1E) onto a desired position on the substrate 20 by means of a single-pass method which performs one operation of relatively moving the substrate 20 and the inkjet head 24 in the y direction, without moving the inkjet head 24 in the x direction, and the ejection speed of the photo-curable resin liquid 25 can be raised.

FIG. 4 is a plan view diagram showing an example of the structure of the inkjet head 24. As shown in FIG. 4, the inkjet head 24 has a structure in which a plurality of head modules 24A (24A-1 to 24A-4) are arranged in a staggered configuration in the x direction.

Furthermore, the head module 24A has a structure in which a plurality of nozzles 23 are arranged in one line in the x direction, and the projected nozzle row obtained by projecting all of the nozzles 23 to an alignment in the x direction is equivalent to a structure in which all of the nozzles 23 are arranged equidistantly in the x direction.

It is also possible to adopt a structure in which a plurality of nozzles 23 are arranged in a matrix configuration. For example, a possible example is a structure in which a plurality of nozzles 23 are arranged in a row direction following the x direction and an oblique column direction which forms a prescribed angle with respect to the x direction.

FIG. 5 is a schematic drawing showing a further example of the composition of the photo-curable liquid ejection unit 12. The photo-curable resin liquid ejection unit 12′ shown in FIG. 5 comprises a serial type inkjet head 24′, and the inkjet head 24′ is mounted on a carriage 29 which is movable along a guide 27 provided in the x direction.

The photo-curable liquid ejection unit 12′ shown in FIG. 5 is composed in such a manner that the photo-curable resin liquid 25 is ejected in terms of the x direction while performing a scanning action (moving action) of the inkjet head 24′ in the x direction, the substrate 20 is moved by a prescribed amount in the y direction when one scanning action in the x direction has been completed, ejection of photo-curable resin liquid 25 is performed onto the next region, and by repeating this operation, photo-curable resin liquid is disposed over the whole surface of the substrate 20.

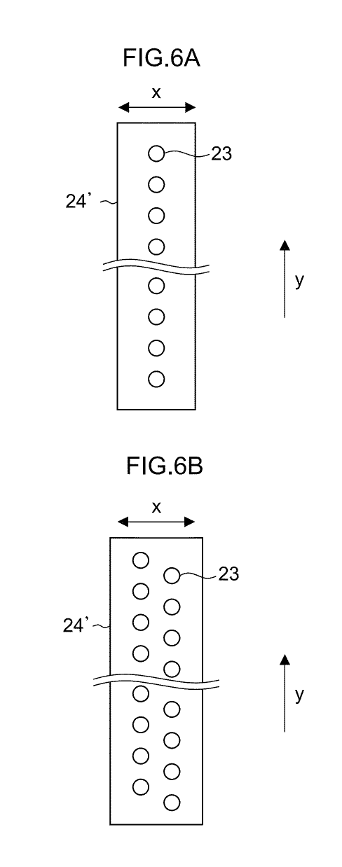

FIGS. 6A and 6B are plan view diagrams showing examples of a nozzle arrangement of a serial type inkjet head 24′ shown in FIG. 5. As shown in FIG. 6A, the inkjet head 24′ has a structure in which a plurality of nozzles 23 are arranged in the y direction. As shown in FIG. 6B, it is possible to arrange a plurality of nozzles 23 in a staggered fashion, whereby the substantial nozzle pitch in the y direction can be reduced.

### [Structure of Inkjet Head]

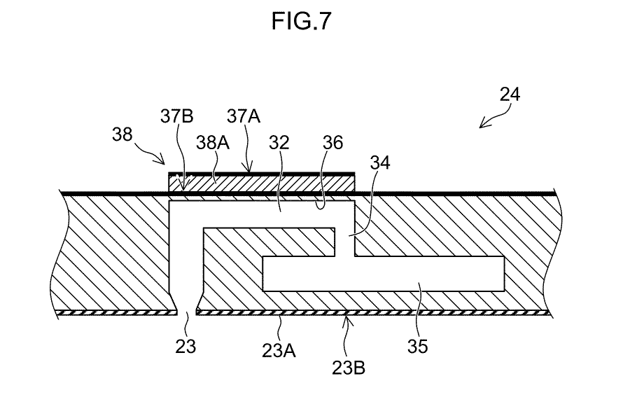

FIG. 7 is a cross-sectional diagram showing a composition of droplet ejection element of one channel of an inkjet head 24. As shown in FIG. 7, the inkjet head 24 according to the present embodiment has a structure in which a nozzle plate 23A in which openings of a plurality of nozzles 23 are formed, and a flow channel plate in which flow channels such as pressure chambers 32 and a common flow channel 35, and the like, are formed, and the like, are layered and bonded together.

The nozzle plate 23A constitutes a nozzle surface 23B of the inkjet head 24, and a plurality of nozzles 23 which connect respectively to the pressure chambers 32 are formed in the nozzle plate 23A.

The flow channel plate is a flow channel forming member which constitutes side wall portions of the pressure chambers 32 and in which supply ports 34 are formed to serve as restricting sections (most constricted portions) of individual supply channels for guiding ink to the respective pressure chambers 32 from the common flow channel 35.

For the sake of the description, a simplified view is given in FIG. 7, but the flow channel plate has a structure formed by layering together one or a plurality of substrates. The nozzle plate 23A and the flow channel plate can be processed into a required shape by a semiconductor manufacturing process using silicon as a material.

The common flow channel 35 is connected to an ink tank (not shown) which is a base tank that supplies ink, and the ink supplied from the ink tank is supplied through the common flow channel 35 to the pressure chambers 32.

A piezoelectric element 38 comprising an upper (individual) electrode 37A and a lower (common) electrode 37B and having a structure in which a piezoelectric body 38A is sandwiched between the upper electrode 37A and the lower electrode 37B is bonded onto a diaphragm 36 which constitutes a portion of the surface of the pressure chamber 32 (the ceiling face in FIG. 7).

If the diaphragm 36 is constituted by a metal thin film or a metal oxide film, then the diaphragm 36 also functions as a common electrode which corresponds to the lower electrode 37B of the piezoelectric element 38. In a mode in which a diaphragm is made from a non-conductive material, such as resin, a lower electrode layer made of a conductive material, such as metal, is formed on the surface of the diaphragm member.

When a drive voltage is applied to the upper electrode 37A, the piezoelectric element 38 deforms, thereby changing the volume of the pressure chamber 32. This causes a pressure change which results in ink being ejected from the nozzle 23. When the piezoelectric element 38 returns to its original position after ejecting ink, the pressure chamber 32 is replenished with new ink from the common flow channel 35 via the supply port 34.

### [Description of Control System]

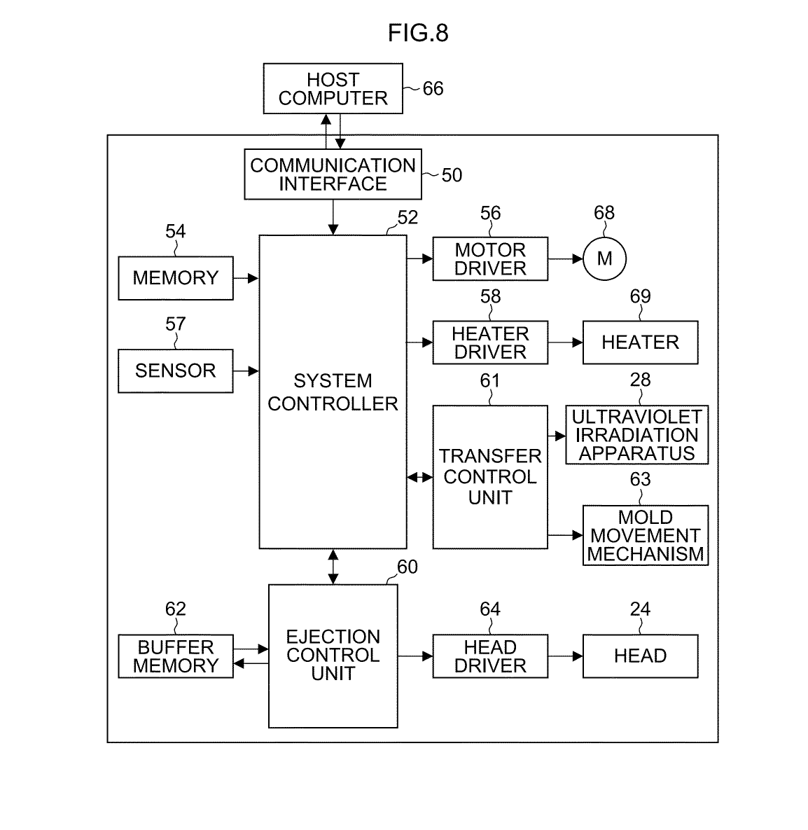

FIG. 8 is a block diagram showing an approximate composition of a control system of the nano-imprinting system (nano-imprinting apparatus) 10. The control system shown in FIG. 8 comprises a communication interface 50, a system controller 52, a memory 54, a motor driver 56, a heater driver 58, an ejection controller 60, a transfer control unit 61, a buffer memory 62, a head driver 64, and the like.

The communication interface 50 is an interface unit which receives data representing an arrangement distribution of the photo-curable resin liquid 25 (see FIGS. 1B to 1 E) which is sent from the host computer 66. It is possible to employ a serial interface or a parallel interface for the communication interface 50. It is also possible to install a buffer memory (not illustrated) in this part for achieving high-speed communications.

The system controller 52 is a control unit that controls other units such as the communication interface 50, memory 54, motor driver 56, and heater driver 58. The system controller 52 is constituted by a central processing unit (CPU) and peripheral circuits thereof, controls communication with the host computer 66, performs reading-writing control of the memory 54, and generates control signals that control the motor 68 of the conveying system or the heater 69.

The memory 54 is a storage unit that is used as a temporary storage region for data and an operation region when the system controller 52 performs various operations. Data on the arrangement of the photocurable resin liquid 25 inputted via the communication interface 50 are taken into the nanoimprint system 10 and stored temporarily in the memory 54. A memory constituted by semiconductor elements and also a magnetic medium such as a hard disk can be used as the memory 54.

Furthermore, the memory 54 stores information about the viscosity of the photo-curable resin liquid 25 and information about mechanical properties, such as a resonance period of the inkjet head 24, and the like. The viscosity information of the photo-curable resin liquid 25 may be input from a user interface (not illustrated), or may be read in automatically from an information storage medium (e.g. IC tag, or the like) which is attached to a container which accommodates the photo-curable resin liquid 25.

Furthermore, the information about mechanical properties, such as the resonance period of the inkjet head 24, is ascertained in advance when the inkjet head 24 is manufactured, and is stored together with various other parameters when the inkjet head 24 is installed in the apparatus (system).

Apart from a memory formed with a semiconductor element, it is also possible to use a magnetic medium, such as a hard disk, for the memory 54.

The motor driver 56 is a driver (drive circuit) which drives the motor 68 in accordance with instructions from the system controller 52. The motor 68 includes a motor for driving the conveyance unit 22 in FIG. 2 and a motor for raising and lowering the mold 26.

The heater driver 58 is a driver which drives the heater 69 in accordance with instructions from the system controller 52. The heater 69 includes heaters for temperature adjustment which is provided in the respective units of the nano-imprinting system 10 (for instance, a heater which heats the substrate 20 before photo-curable resin liquid 25 is disposed thereon).

The ejection controller 60 is a control unit which has signal processing functions for carrying out processing, correction, and other treatments in order to generate an ejection control signal on the basis of the arrangement data of the photo-curable resin liquid 25 in the memory 54, and which supplies the ejection control signal thus generated to the head driver 64, in accordance with control implemented by the system controller 52.

In the ejection controller 60, required signal processing is carried out and the ejection volume and ejection position of the photo-curable resin liquid 25 ejected from the inkjet head 24 and the ejection timing of the inkjet head 24 are controlled via the head driver 64 on the basis of the arrangement data. By this means, a desired arrangement (distribution) of droplets of the photo-curable resin liquid 25 is achieved.

A buffer memory 62 is provided in the ejection controller 60, and data, such as arrangement data and parameters, is stored temporarily in the buffer memory 62 when processing the arrangement data in the ejection controller 60. In FIG. 8, the buffer memory 62 is depicted as being attached to the ejection controller 60, but may also be combined with the memory 54.

Also possible is a mode in which the ejection controller 60 and the system controller 52 are integrated to form a single processor.

The head driver 64 generates drive signals for driving the piezoelectric elements 38 (see FIG. 7) of the inkjet head 24, on the basis of ejection data supplied from the ejection controller 60, and supplies the generated drive signals to the piezoelectric elements 38. The head driver 64 may also incorporate a feedback control system for maintaining uniform drive conditions in the inkjet head 24.

The sensor 57 includes sensors of various types which are provided in respective units of the system (apparatus), such as a sensor (imaging element) for determining the state of flight of the droplets ejected from the inkjet head 24, a sensor for determining the position of the substrate 20, and the like.

The information obtained by the sensors 57 is sent to the system controller 52 and is used to control the respective units of the apparatus.

The transfer control unit 61 controls the operation of the mold movement mechanism 63 which moves the mold 26 (see FIG. 2), as well as controlling the on/off switching and the amount of irradiated light of the ultraviolet irradiation apparatus 28. In other words, when the substrate 20 onto which photo-curable resin liquid has been applied is conveyed to the pattern transfer unit 14, the mold 26 is moved and pressed against the substrate 20, and ultraviolet light is irradiated from the ultraviolet irradiation apparatus 28.

When the topographical pattern of the mold 26 has been transferred, the photo-curable resin liquid 25 has been cured and a mask pattern has been formed by the photo-curable resin layer 25″ (see FIGS. 1B to 1E), then the ultraviolet irradiation is halted and the mold 26 is separated from the substrate.

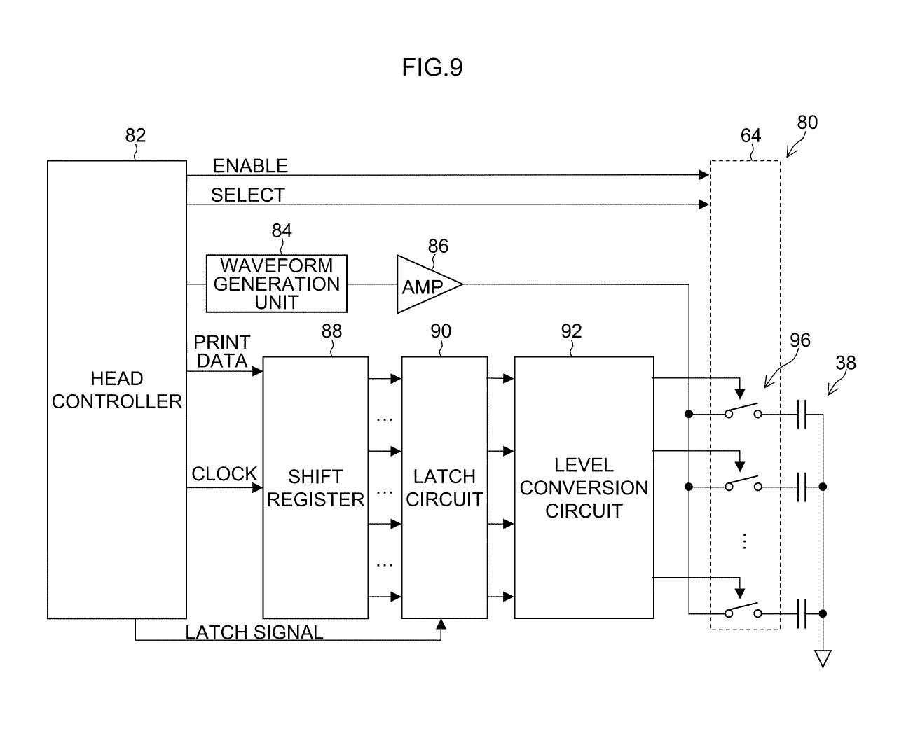

FIG. 9 is a block diagram showing an example of the composition of a head driver 64. The compositional example shown in FIG. 9 comprises a drive waveform generation unit 84 which generates a waveform signal in an analog format (drive waveform) on the basis of a waveform signal in a digital format which is sent from the head controller 82 (which corresponds to the system controller 52 and the ejection controller 60 in FIG. 8), and an amplifier unit (AMP) 86 which amplifies the voltage and current of the drive waveform.

The serial print data transferred from the head controller 82 is sent to a shift register 88, together with a clock signal, in synchronism with the clock signal. The drive waveform generated by the drive waveform generating unit 84 includes a plurality of waveform elements. By selecting one or a plurality of waveform elements from these plurality of waveform elements, it is possible to change the ejection volume of the photo-curable resin liquid 25 in a stepwise fashion.

The print data stored in the shift register 88 is latched in a latch circuit 90 on the basis of a latch signal. The signal latched in the latch circuit 90 is converted to a prescribed voltage capable of driving a switching element 96 which constitutes the switch IC 94, in a level conversion circuit 92.

By controlling the on/off switching of the switching elements 96 by means of the output signal from the level conversion circuit 92, at least one waveform element is selected from the plurality of waveform elements, thereby deciding the ejection volume, and the piezoelectric element 38 to be driven is selected by means of a select signal and an enable signal output from the head controller 82.

The inkjet head 24 drive system is not limited to a system which selectively applies a common drive voltage (drive waveform) and in an inkjet head having a relatively small overall number of nozzles, it is also possible to employ a system in which a drive waveform is generated for each nozzle.

### [Description of Drive Voltage (Waveform)]

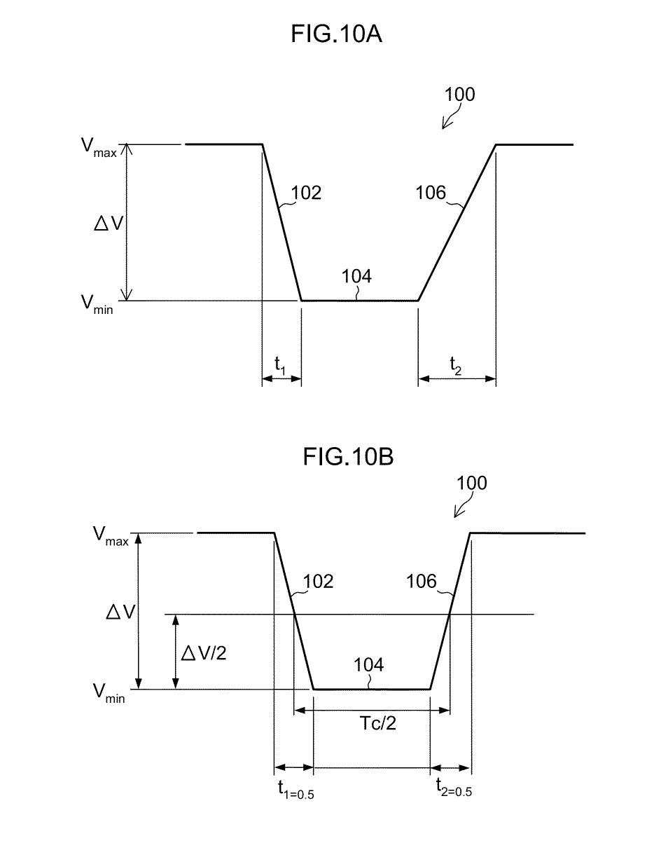

Next, the drive voltage employed in the present embodiment will be described in detail. FIG. 10A is an illustrative diagram of a drive voltage which is applied to a piezoelectric element 38 provided in an inkjet head 24.

The drive voltage 100 shown in FIG. 10A includes a pull waveform 102 for causing the piezoelectric element 38 to operate so as to expand the pressure chamber 32 from a steady state (see FIG. 7), a hold waveform 104 for causing the piezoelectric element 38 to operate so as to maintain the expanded state of the pressure chamber 32, and a push waveform 106 for contracting the expanded pressure chamber 32.

More specifically, the drive waveform 100 shown in FIG. 10A deforms the pressure chamber 32 by pull-push driving of the piezoelectric element 38, and causes a droplet to be ejected from the nozzle 23 (see FIG. 7) by utilizing a resonance effect of the pressure chamber 32 and the photo-curable resin liquid.

The slope γ₁ of the pull waveform 102 is determined so as to satisfy the relationship shown in Formula (1) below with respect to the viscosity η of the photo-curable resin liquid.

γ₁≦(η/10) [Formula (1)]

The slope γ₂ of the push waveform is determined so as to satisfy the relationship shown in Formula (2) below with respect to the viscosity η of the photo-curable resin liquid.

γ₂≦(η/10) [Formula (2)]

The coefficient “ 1/10” of the element of the photo-curable resin liquid viscosity η in Formula (1) and Formula (2) is expressed in units of “1/(nPa·s²)” (1/nanopascals·second squared).

Moreover, the slope γ₁ of the pull waveform 102 and the slope γ₂ of the push waveform 106 satisfy the relationship in Formula (3) below.

γ₂≦γ₁ [Formula (3)]

The slope (slew rate) γ of the drive voltage is the rate of voltage change per unit time (one microsecond) when the difference ΔV between the maximum value Vₘₐₓ and the minimum value Vₘᵢₙ of the drive voltage is taken as 1. The difference ΔV between the maximum value Vₘₐₓ and the minimum value Vₘᵢₙ of the drive voltage 100 is optimized in accordance with the conditions for obtaining the prescribed ejection speed of the droplets which are ejected from the nozzles.

The slope γ₁ of the pull waveform 102 is expressed by Formula (4) below, using the time t₁ of the pull waveform 102.

γ₁=1/t₁ [Formula (4)]

Furthermore, the slope γ₂ of the push waveform 106 is expressed by Formula (5) below, using the time t₂ of the push waveform 106.

γ₂=1/t₂ [Formula (5)]

For example, the slope γ when the voltage changes from the minimum voltage to maximum voltage in one microsecond is “1”, and the slope γ when the voltage changes from the minimum voltage to maximum voltage in two microseconds is “0.5”.

It is also possible to adopt a mode which omits the hold waveform 104 of the drive voltage 100 shown in FIG. 10A. In other words, it is sufficient for the drive voltage 100 to include at least the pull waveform 102 and the push waveform 106.

Here, the calculations in Formulas (1) to (3) described above will be explained. As disclosed in Patent Literature 3 (“PTL 3”), it is known that the shape of the ejected droplet changes with the meniscus vibration mode.

Consequently, if the slew rate of the drive voltage is changed, then the vibration induced in the meniscus of the nozzle 23 can be changed, and therefore the ejection state of the droplets can be changed.

On the other hand, as disclosed in Patent Literature 3, although it is possible to derive the drive voltage for changing the droplet ejection volume by analysis, it is analytically difficult to evaluate the stability of continuous high-speed ejection.

Therefore, the inventors investigated the optimal drive voltage (drive waveform) for preventing the occurrence of mist and recovering ink that has spilled out from the nozzles, by taking account of how the stability of continuous ejection is influenced by the combined effects of mist which adheres to the vicinity of the nozzles 23 (see FIG. 7) and ink which spills out slightly from the nozzles during ejection.

As described above, since the vibration mode of the meniscus in the nozzles 23 can be altered by means of the slew rate γ of the drive voltage, the inventors focused their attention on the slew rate γ of the drive voltage. Furthermore, since it is considered that the vibration mode of the meniscus can be altered by means of the viscous resistance of the liquid in the nozzles 23, then the inventors also focused attention on the viscosity of the photo-curable resin liquid.

As described below, a relationship between the slew rate γ of the drive voltage and the viscosity η of the photo-curable resin which enables stable continuous ejection was investigated by evaluation and experimentation. The main vibration period of the vibration mode of the meniscus is the resonance period T_{c} of the inkjet head 24, and therefore the slew rate γ of the drive voltage was evaluated by comparison with the resonance period T_{c} of the inkjet head 24.

The resonance period T_{c} of the inkjet head 24 in the evaluation and experimentation described below is decided as indicated below.

As shown in FIG. 10B, when ejection was performed from the inkjet head 24 using fixed slopes of γ₁=γ₂=0.5 (t₁=t₂) while altering the pulse width, the resonance period T_{c} was taken to be two times the pulse width when the maximum ejection speed was achieved.

Here, the pulse width was decided to be the “time interval from the timing of 50% of the voltage difference ΔV between the maximum voltage Vₘₐₓ and the minimum voltage Vₘᵢₙ in the pull waveform 102 until the timing of 50% of the voltage difference ΔV between the maximum voltage Vₘₐₓ and the minimum voltage Vₘᵢₙ in the push waveform 106”.

In other words, the time interval from the timing of 50% of the voltage difference ΔV between the maximum voltage Vₘₐₓ and the minimum voltage Vₘᵢₙ in the pull waveform 102 until the timing of 50% of the voltage difference ΔV between the maximum voltage Vₘₐₓ and the minimum voltage Vₘᵢₙ in the push waveform 106 is ½ of the resonance period T_{c}.

### [Evaluation Experiments]

Using a Dimatix Material printer, DMP-2831 (made by FUJIFILM Dimatix, Inc.) as the experimental apparatus, droplets were ejected continuously from the inkjet head and images of the state of flight of the droplets were captured using an observational camera built into the apparatus.

The images of droplets immediately after the start of continuous ejection were compared with images of droplets immediately before the end of continuous ejection, taking the ejection frequency as a parameter, using a continuous ejection of 3 minutes and setting the viscosity η of the photo-curable resin liquid to 5 mPa·s, 7.5 mPa·s and 10 mPa·s during the ejection by adjusting the temperature of the inkjet head.

The amplitude of the drive voltage (ΔV in FIGS. 10A and 10B) was adjusted in such a manner that the droplet ejection speed was uniform under each of the conditions. More specifically, the amplitude of the drive voltage was adjusted in such a manner that the distance of flight of the droplet was 300 micrometers, at 37 microseconds after application of the drive voltage.

The results of this evaluation experiment are given below. In the evaluation results shown below, the evaluation “◯” (circle, open dot) indicates that stable continuous ejection was achieved at an ejection frequency of 20 kilohertz or above. The evaluation “x” (cross mark) indicates that stable continuous ejection was achieved at an ejection frequency of 5 kilohertz or below, but stable continuous ejection was not achieved when the ejection frequency exceeded 5 kilohertz.

The evaluation “Δ” (triangle) indicates that stable continuous ejection was achieved at an ejection frequency below 20 kilohertz, but stable continuous ejection was not achieved when the ejection frequency was 20 kilohertz or above.

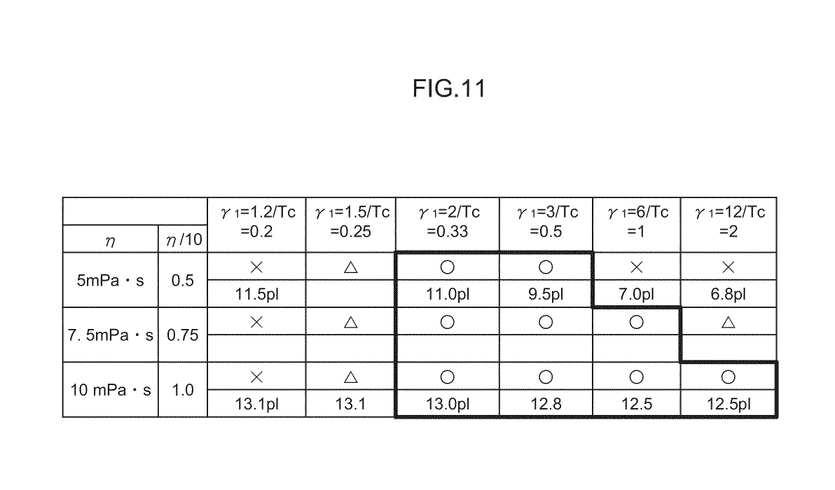

FIG. 11 shows the evaluation results when the slope γ₁ of the pull waveform 102 in FIGS. 10A and 10B was changed in steps from (1.2/T_{c}=0.2) to (12/T_{c}=2.0). The resonance period T_{c} of the inkjet head 24 is 6.0 microseconds. Furthermore, γ₂ is γ₂=2/T_{c}.

As shown in FIG. 11, when the slope γ₁ of the pull waveform 102 became large (steep), then the ejection stability improved. On the other hand, in the case of low viscosity, if the slope γ₁ of the pull waveform 102 became too steep, then the ejection stability declined. Consequently, when the viscosity η of the photo-curable resin liquid is in a range from 5 mPa·s to 10 mPa·s, stable continuous ejection at high speed is possible by making the relationship between the slope γ₁ and the viscosity η satisfy the relationship in Formula (1) above.

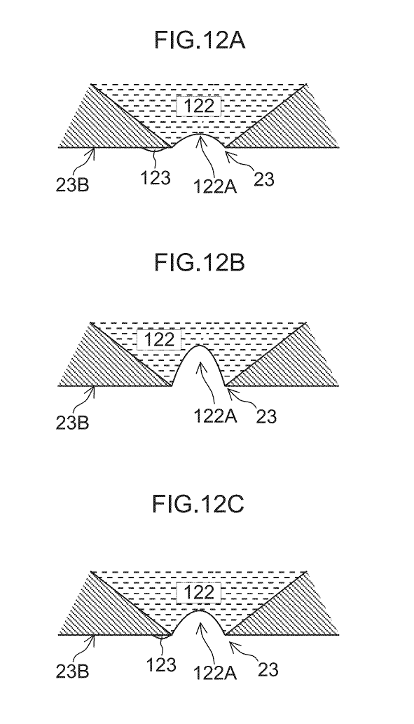

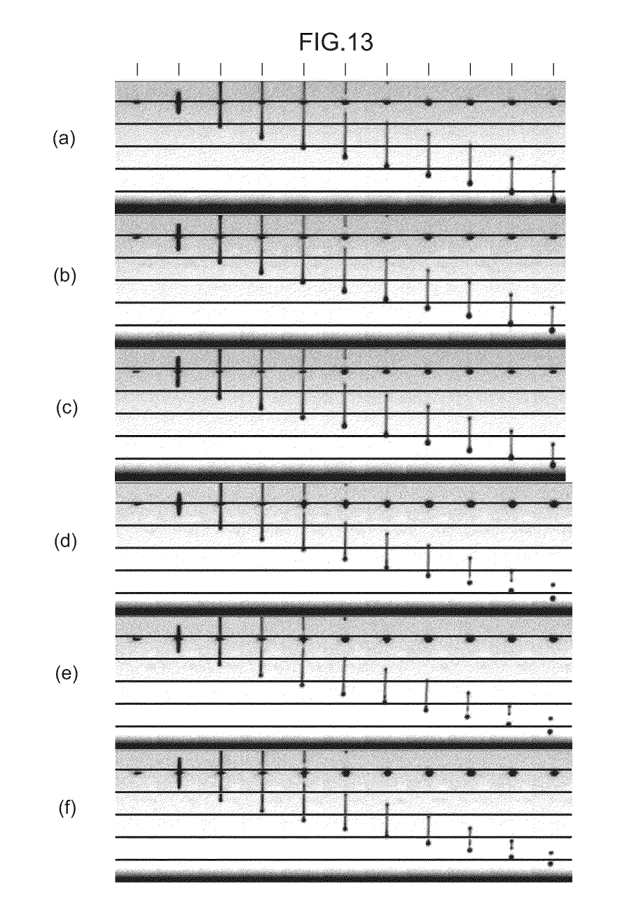

FIGS. 12A to 12C are illustrative diagrams showing schematic views of the behavior of a meniscus depending on difference in the slope γ₁ of the pull waveform 102. FIG. 12A shows a steady state before the meniscus 122A is pulled inside the nozzle 23 in which mist 123 is adhering to the nozzle surface 23B.

FIG. 12B shows a state where the meniscus 122A has been pulled inside the nozzle 23, and the slope γ₁ of the pull waveform 102 is steep. In this state, the mist 123 on the nozzle surface 23B is pulled inside the nozzle 23 and consequently, it is considered that stable high-speed continuous ejection is possible.

FIG. 12C shows a state where the meniscus 122A has been pulled inside the nozzle 23, and the slope γ₁ of the pull waveform 102 is gentle. If the slope γ₁ of the pull waveform 102 is gentle, then it is considered that the pulling force into the nozzle 23 is weak, mist 123 on the nozzle surface 23B cannot be recovered inside the nozzle 23, and stable continuous ejection cannot be achieved.

(a) to (f) of FIG. 13 are images of the droplets ejected from the nozzles 23 captured at 5 microsecond intervals. The increments on the horizontal scale shown in the upper part of (a) of FIG. 13 each represent 5 microseconds, and the vertical scale represents distance.

The ejection conditions in (a) to (c) of FIG. 13 relate to cases where the viscosity η=10 mPa·s, and the slope γ₂ of the push waveform 106 is γ₂=2/T_{c} (uniform); (a) of FIG. 13 shows a case where the slope γ₁ of the pull waveform is 2/T_{c} (=0.33), (b) of FIG. 13 shows a case where the slope γ₁ of the pull waveform is 3/T_{c} (=0.5) and (c) of FIG. 13 shows a case where the slope γ₁ of the pull waveform is 6/T_{c} (=1.0).

Furthermore, the ejection conditions in (d) to (f) of FIG. 13 relate to cases where the viscosity η=5 mPa·s, and the slope γ₂ of the push waveform 106 is γ₂=2/T_{c} (=0.33); (d) of FIG. 13 shows a case where the slope γ₁ of the pull waveform 102 is 2/T_{c} (=0.33), (e) of FIG. 13 shows a case where the slope γ₁ of the pull waveform 102 is 3/T_{c} (=0.5) and (f) of FIG. 13 shows a case where the slope γ₁ of the pull waveform 102 is 6/T_{c} (=1.0).

Looking at (a) to (f) of FIG. 13, the ejection volume is reduced when the viscosity η is 5 mPa·s, compared to when the viscosity η is 10 mPa·s, and furthermore, the ejection volume is also reduced when the slope γ₁ of the pull waveform 102 becomes steeper.

Consequently, when the viscosity η is low, then if the slope γ₁ of the pull waveform 102 is too steep, the ejection volume becomes too small and it is considered that the ejection becomes instable.

More specifically, stable high-speed continuous ejection is achieved by making the slope γ₁ of the pull waveform 102 and the viscosity η of the photo-curable resin liquid satisfy the relationship in Formula (1) above.

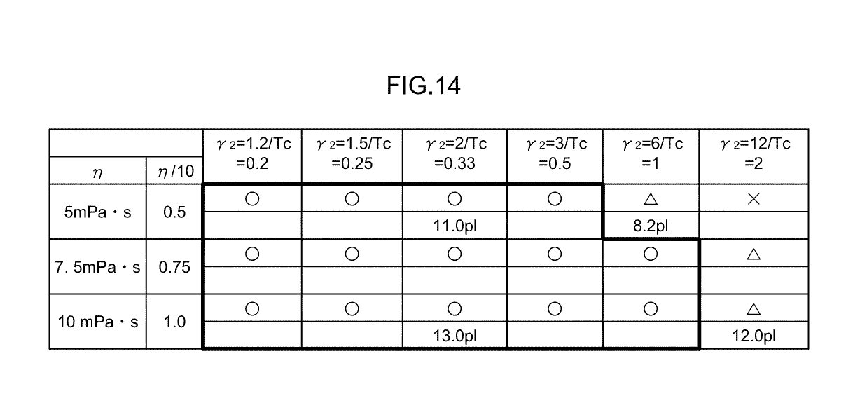

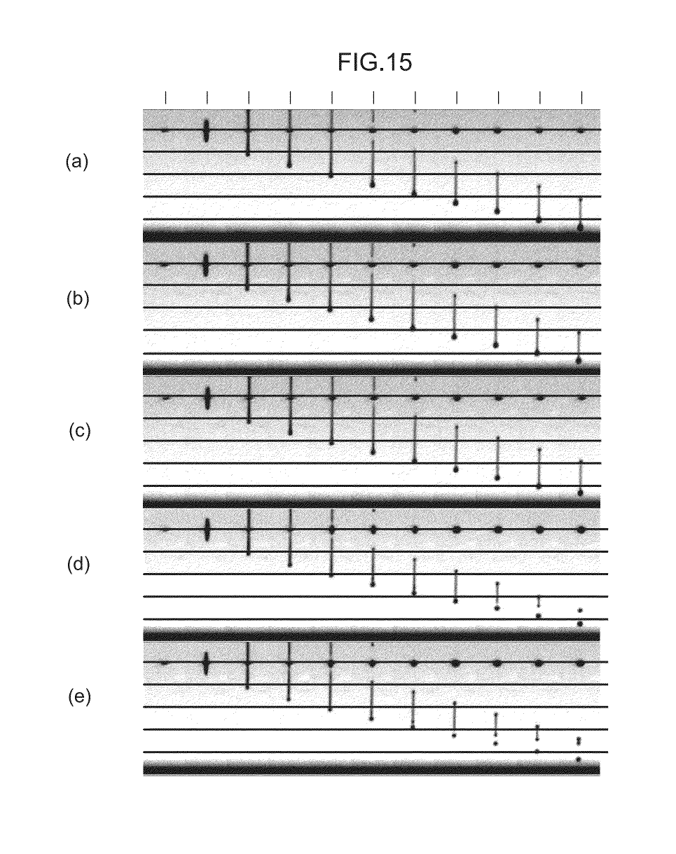

FIG. 14 shows the evaluation results when the slope γ₂ of the push waveform 106 was changed in steps from (1.2/T_{c}=0.2) to (12/T_{c}=2.0). Furthermore, γ₁ was γ₁=3/T_{c}.

As shown in FIG. 14, if the slope γ₂ of the push waveform 106 became small (gentle), then the ejection stability was improved. Moreover, in the case of low viscosity, if the slope γ₂ of the push waveform 106 became too steep, then the ejection stability declined.

(a) to (e) of FIG. 15 are images of the droplets ejected from the nozzles 23 captured at 5 microsecond intervals. The increments on the horizontal scale shown in the upper part of (a) of FIG. 15 each represent 5 microseconds, and the vertical scale represents distance.

The ejection conditions in (a) to (c) of FIG. 15 relate to cases where the viscosity η is η=10 mPa·s and the slope γ₁ of the pull waveform 102 is γ₁=3/T_{c} (=0.5); (a) of FIG. 15 shows a case where the slope γ₂ of the push waveform 106 is 2/T_{c} (=0.33), (b) of FIG. 15 shows a case where the slope γ₂ of the push waveform 106 is 3/T_{c} (=0.5), and (c) of FIG. 15 shows a case where the slope γ₂ of the push waveform 106 is 6/T_{c} (=1.0).

Furthermore, the ejection conditions in (d) and (e) of FIG. 15 relate to cases where the viscosity η is η=5 mPa·s and the slope γ₁ of the pull waveform 102 is γ₁=3/T_{c} (=0.5); (d) of FIG. 15 shows a case where the slope γ₂ of the push waveform 106 is 2/T_{c} (=0.33) and (e) of FIG. 15 shows a case where the slope γ₂ of the push waveform 106 is 6/T_{c} (=1.0).

Looking at (a) to (e) of FIG. 15, it can be seen that if the slope γ₂ of the push waveform 106 is steep, then the trailing end of the ejected droplet (liquid column) cannot catch up with the front end of the droplet successfully. More specifically, if the length of the liquid column on the right-hand end in (a) of FIG. 15 is compared with the length of the liquid column on the right-hand end in (c) of FIG. 15, then it can be seen that the length of the liquid column on the right-hand end in (a) of FIG. 15 is shorter and the trailing end of the liquid column catches up with the leading end more successfully.

More specifically, by making the slope γ₂ of the push waveform 106 gentle, the trailing end of the ejected droplet catches up with the leading end more successfully, and occurrence of mist is prevented, and hence stable continuous ejection is achieved.

Furthermore, if the liquid column on the right-hand end of the (d) of FIG. 15 and the liquid column on the right-hand end of the (e) of FIG. 15 are compared, then it can be seen that the liquid column on the right-hand end of (e) of FIG. 15 splits into three parts and the ejection volume decreases. Consequently, when the viscosity η is low, then if the slope γ₂ of the push waveform 106 is too steep, the ejection volume becomes too small and it is considered that the ejection state becomes instable.

More specifically, stable high-speed continuous ejection (at 20 kilohertz) is achieved by making the slope γ₂ of the push waveform 106 and the viscosity η of the photo-curable resin liquid satisfy the relationship in Formula (2) above.

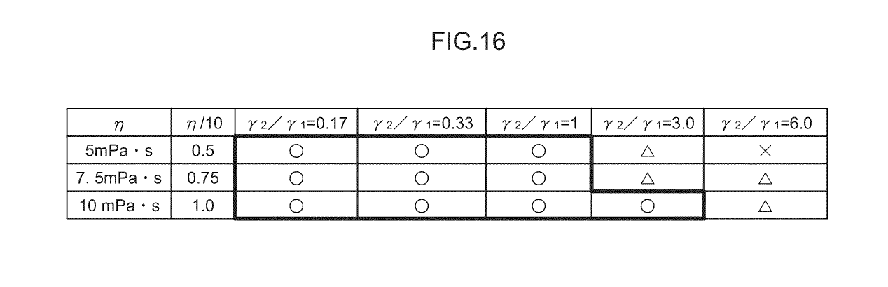

FIG. 16 shows the evaluation results when the ratio (γ₂/γ₁) between the slope γ₁ of the pull waveform 102 and the slope γ₂ of the push waveform 106 was changed. As shown in FIG. 11 to FIG. 15, it can be seen that the slope γ₁ of the pull waveform 102 is desirably steep and the slope γ₂ of the push waveform 106 is desirably gentle, and therefore stable high-speed continuous ejection is possible if the relationship between the slope γ₁ of the pull waveform 102 and the slope γ₂ of the push waveform 106 satisfies Formula (3′) below.

(γ₂/γ₁)≦1 [Formula (3′)]

Rearranging Formula (3′) above gives Formula (3) which is stated previously.

Here, from FIG. 11, the lower limit value of the slope γ₁ of the pull waveform 102 is expressed by Formula (6) below, using the resonance frequency T_{c} of the inkjet head 24.

(2/T_{c})≦γ₁ [Formula (6)]

Further, similarly to the slope γ₁, the slope γ₂ desirably satisfies Formula (7) below.

(2/T_{c})≦γ₂ [Formula (7)]

To represent the slope γ of the drive voltage, including the slope γ₁ of the pull waveform 102 and the slope γ₂ of the push waveform 106, then the Formulas (1), (2), (6) and (7) above can be expressed as indicated in Formula (8) below.

(2/T_{c})≦−≦(η/10) [Formula (8)]

By using a drive voltage which includes the pull waveform 102 and the push waveform 106 shown in FIGS. 10A and 10B and has a slope γ whereby the relationship between the resonance frequency T_{c} of the inkjet head 24 and the viscosity η of the photo-curable resin liquid accommodated in a pressure chamber 32 satisfies Formula (8) above when ejecting droplets of photo-curable resin liquid of high viscosity accommodated in the pressure chamber 32 by expanding the pressure chamber 32 (see FIG. 7) from a steady state and then contracting the pressure chamber 32, it is possible to achieve stable high-speed continuous ejection, even if there is change in the viscosity of the photo-curable resin liquid caused by evaporation of solvent in the photo-curable resin liquid or change in the ambient temperature.

Furthermore, by adopting a composition in which the slope γ₁ of the pull waveform 102 and the slope γ₂ of the push waveform 106 satisfy the relationship in Formula (3) above, it is possible to improve the robustness of high-speed continuous ejection.

In the evaluation experiment described above, the viscosity η of the photo-curable resin liquid was changed in a range from 5 mPa·s to 10 mPa·s, but as described below, these evaluation experiment results can be applied to liquid at or below 20 mPa·s, which is in a viscosity range that can be ejected by an inkjet method.

If the viscosity η of the photo-curable resin liquid exceeds 10 mPa·s, then the pulled-in shape of the meniscus created by the pull waveform becomes more gentle. For example, the meniscus shape becomes closer to the shape of the meniscus 122A shown in FIG. 12C, than the shape of the meniscus 122A shown in FIG. 12B.

In this case, since the size of the ejected droplets does not become smaller, than the ejection state is stable, even if the slope γ₁ of the pull waveform 102 shown in FIG. 10A is raised.

Moreover, if the viscosity η of the photo-curable resin liquid exceeds 10 mPa·s, then the viscosity of the photo-curable resin liquid serves as a flow channel resistance, and therefore the possibility of mist occurring with variation in the slope γ₂ of the push waveform 106 is further reduced. Consequently, it is possible to make the slope γ₂ of the push waveform 106 even larger.

[Relationship with Nozzle Shape]

Next, the relationship between the shape of the nozzles 23 provided in the inkjet head 24 and the ejection stability will be described in detail.

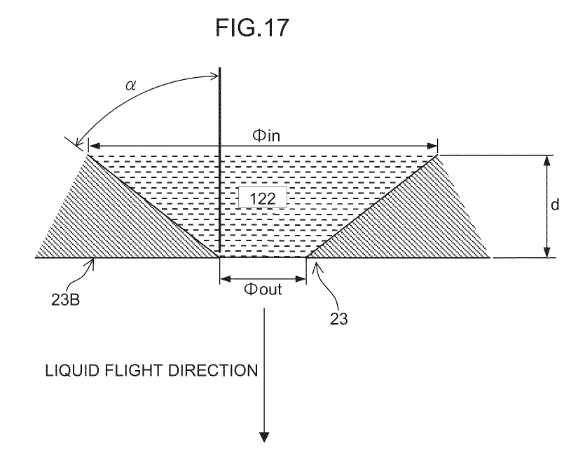

FIG. 17 is a cross-sectional diagram showing the shape of a nozzle 23. As shown in FIG. 17, by forming the nozzle 23 with a tapered shape (an approximate round conical shape), it is possible to improve the robustness of the ejection volume of the droplets 25 of photo-curable resin liquid.

This is thought to be because forming the nozzle 23 in a tapered shape as shown in FIG. 17 reduces the viscous resistance between the nozzle 23 and the photo-curable resin liquid in the nozzle 23, and thus lowers the contribution of the viscous resistance when ejecting the photo-curable resin liquid.

Therefore, considering an equivalent circuit model based on a lumped constant, the ejected droplet volume depends on the acoustic impedance. The acoustic resistance R and the acoustic inertance L in nozzle 23 are calculated and their contributions to the acoustic impedance are compared.

If the total length of the nozzle 23 is represented by d, the cross-sectional surface of the opening part on the ejection side of the nozzle 23 is represented by S, and the density of the photo-curable resin liquid inside the nozzle 23 is represented by p, then the acoustic resistance R is expressed by Formula (9) below and the acoustic inertance L is expressed by Formula (10) below.

R=(8×π×η×d)/S² [Formula (9)]

L=(ρ×d)/S [Formula (10)]

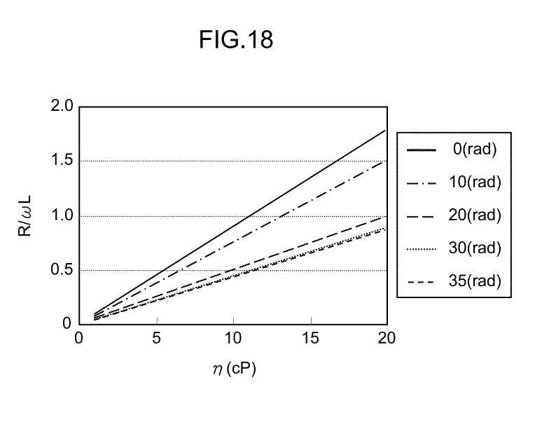

FIG. 18 shows a relationship between the acoustic impedance (R/ωL) and the viscosity η of the photo-curable resin liquid, when the angle of taper α is taken as a parameter. ω is a resonance angular frequency which is calculated from the resonance period T_{c} which is determined experimentally, and in practical terms, ω=2×n/T_{c}=785×10³ radian/sec.

The taper angle is the angle of inclination of the inclined surface linking the opening on the ejection side and the opening on the liquid chamber side, with respect to the normal to the opening surface on the ejection side.

As shown in FIG. 18, it can be seen that the contribution of the acoustic resistance R is reduced by increasing the taper angle α, and the change in the acoustic impedance with respect to the change in the viscosity becomes small. If the angle of taper α is not less than 20°, then there is no difference in the acoustic impedance (R/ωL) with respect to the viscosity η of the photo-curable resin liquid.

As shown in FIG. 18, the characteristics indicated by the broken lines (35°, 20°) and the dotted line (30°) show that there is no difference in the acoustic impedance. Consequently, it is desirable that the angle of taper should be not less than 20°.

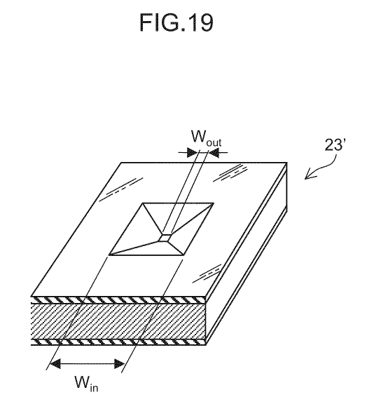

FIG. 19 is a perspective diagram showing a further shape of a nozzle 23. When a silicon substrate is used as the nozzle plate 23A and wet etching is carried out with respect to the surface (100) of the silicon substrate by using KOH (potassium hydroxide) as the etching liquid, then a nozzle 23′ having a square pyramid shape truncated at the tip is formed, as shown in FIG. 19.

The nozzle 23′ shown in FIG. 19 has a taper angle α of 35.26°. This taper angle α gives a desirable nozzle shape which is in a region where the acoustic impedance (R/ωL) does not change with respect to the viscosity η of the photo-curable resin liquid.

The nozzles formed in a silicon substrate by wet etching have a taper angle α of not less than 20°, as described above, and the effect of the viscosity η of the photo-curable resin liquid is small. Furthermore, in nozzles formed by wet etching of a silicon substrate, the taper angle α is determined by the crystal orientation, and hence there is no fluctuation in the taper angle α.

Consequently, the nozzles formed by wet etching of a silicon substrate show little change in ejection characteristics with respect to fluctuation in the viscosity η of the photo-curable resin liquid, and hence the robustness is improved.

### [Explanation of Photocurable Liquid Resin Liquid]

A resist composition (referred to hereinbelow simply as “resist”) will be explained below in greater detail as an example of a photocurable liquid resin liquid for use in the nanoimprint system shown in the present example.

The resist composition is a curable composition for imprinting that includes at least a surfactant containing at least one kind of fluorine, a polymerizable compound, and a photopolymerization initiator I.

The resist composition may include a monofunctional monomer component or a monomer component with higher functionality that has a polymerizable functional group with the object of developing crosslinking ability attained due to the presence of polyfunctional polymerizable groups, increasing the carbon density, increasing the total bonding energy, or increasing etching resistance by suppressing the content ratio of sites with a high electronegativity, such as O, S, and N, contained in the resin after curing. Further, if necessary, a coupling agent for improving coupling to the substrate, a volatile solvent, and an antioxidant can be also contained in the resist composition.

A material similar to the above-described adhesion treatment agent for the substrate can be used as the coupling agent for improving coupling to the substrate. As for the content thereof, the coupling agent may be contained at a level ensuring the presence thereof at the interface of the substrate and the resist layer. The content ratio of the coupling agent may be equal to or less than 10 wt. % (mass %), preferably equal to or less than 5 wt. %, more preferably equal to or less than 2 wt. %, and most preferably equal to or less than 0.5 wt. %.

From the standpoint of inclusion of a solid fraction (component remaining after the volatile solvent component has been removed) contained in the resist composition into the pattern formed on the mold 26 (see FIGS. 6A and 6B) and wetting and spreading ability on the mold 26, it is preferred that the viscosity of the solid fraction be equal to or less than 1000 mPa·s, more preferably equal to or less than 100 mPa·s, and even more preferably equal to or less than 20 mPa·s. However, when an inkjet system is used where jetting is performed at room temperature or the temperature can be controlled by the head during discharging, it is preferred that the viscosity be equal to or less than 20 mPa·s in this temperature range. The surface tension of the resist composition is preferably within a range of 20 mN/m to 40 mN/m (not less than 20 mN/m and not greater than 40 mN/m), more preferably 24 mN/m to 36 mN/m (not less than 24 mN/m and not greater than 36 mN/m) because the discharge stability in ink jetting is ensured.

### [Polymerizable Compound]

A polymerizable compound in which the fluorine content ratio represented by [Equation 1] below is equal to or less than 5% or which contains substantially no fluoroalkyl groups or fluoroalkyl ether groups is taken as the polymerizable compound serving as the main component of the resist composition.

Fluorine Content Ratio={[(Number of Fluorine Atoms in Polymerizable Compound)×(Atomic Weight of Fluorine Atoms)]/(Molecular Weight of Polymerizable Compound)}×100 [Equation 1]

The preferred polymerizable compound has high accuracy of pattern after curing and good quality such as etching endurance. Such polymerizable compound preferably includes a polyfunctional monomer that forms a polymer with a three-dimensional structure when crosslinked by polymerization. The polyfunctional monomer preferably includes at least one divalent or trivalent aromatic group.

In the case of a resist having a three-dimensional structure after curing (polymerization), good shape retention ability after curing is obtained, stresses applied to the resist are concentrated in a specific area of the resist structural body due to adhesion between the mold and the resist during mold separation, and plastic deformation of the pattern is inhibited. However, where the ratio of the polyfunctional monomer that becomes a polymer having a three-dimensional structure after polymerization or the density of sites forming three-dimensional crosslinking after polymerization increases, the Young's modulus after curing increases, deformation ability decreases, and film brittleness increases. Therefore, the film is easily fractured during mold separation. In particular, with the pattern having a pattern size of equal to or less than 30 nm (width) and a pattern aspect ratio of equal to or greater than 2, where the residual film thickness is equal to or less than 10 nm, the probability of pattern peeling off or tearing off increases when the pattern is formed in a wide area, as in the case of hard disk patterns or semiconductor patterns.

Therefore, the content ratio of the polyfunctional monomer in the polymerizable compound is preferably equal to or higher than 10 wt. %, more preferably equal to or higher than 20 wt. %, even more preferably equal to or higher than 30 wt. %, and most preferably equal to or higher than 40 wt. %.

Further, it was found that the crosslinking density represented by the following equation [Equation 2] is preferably 0.01/nm² to 10/nm² (not less than 0.01/nm² and not greater than 10/nm²), more preferably 0.1/nm² to 6/nm² (not less than 0.1/nm² and not greater than 6/nm²), even more preferably 0.5/nm² to 5.0/nm² (not less than 0.5/nm² and not greater than 5.0/nm²). The crosslinking density of the composition is found by determining the crosslinking density of each molecule and then finding the weight-average value, or by measuring the density of composition after curing, and using the weight-averaged values of Mw and (Nf−1) and the following equation [Equation 2].

$$Da = \frac{Na \times Dc}{Mw} \times ( Nf - 1 ) \qquad [ Equation 2 ]$$

Da: crosslinking density of one molecule.
Dc: density after curing.
Nf: the number of acrylate functional groups contained in one molecule of the monomer.
Na: Avogadro's constant.
Mw: molecular weight.

In this equation, Da is a crosslinking density of one molecule, Dc is a density after curing, Nf is the number of acrylate functional groups contained in one molecule of the monomer, Na is the Avogadro's constant, and Mw is a molecular weight.

The polymerizable functional groups of the polymerizable compound are not particularly limited, but from the standpoint of reactivity and stability, a methacrylate group and an acrylate group are preferred, and an acrylate group is especially preferred.

Dry etching resistance can be estimated by an Ohnishi parameter and a ring parameter of the resist composition. Excellent dry etching ability is obtained when the Ohnishi parameter is small and the ring parameter is large. According to the present invention, in the resist composition the Ohnishi parameter is equal to or less than 4.0, preferably equal to or less than 3.5, and more preferably equal to or less than 3.0, and the ring parameter is equal to or greater than 0.1, preferably equal to or greater than 0.2, and more preferably equal to or greater than 0.3.

The above-mentioned parameters are determined by calculating material parameter values, by using the below-described computational formulas on the basis of structural formulas, with respect to constituent substances, other than the volatile solvent component, constituting the resist composition and averaging the calculated material parameter values for the entire composition on the basis of compounding weight ratios. Therefore, with respect to the polymerizable compound, which is the main component of the resist composition, the selection is preferably made with consideration for the above-mentioned parameters and other components contained in the resist composition.

Ohnishi parameter=(total number of atoms in composition)/{(number of carbon atoms in composition)−(number of oxygen atoms in composition)}.

Ring parameter=(carbon mass forming a ring structure)/(total mass of compound).

The below-describes polymerizable monomers and oligomers obtained by polymerization of several units of the polymerizable monomers are examples of the polymerizable compounds. From the standpoint of pattern formation ability and etching resistance, it is preferred that at least one compound from among the polymerizable monomer (Ax) and the compounds described in paragraphs [0032] to [0053] of the description of Patent Literature 4 (“PTL 4”) be included.

### [Polymerizable Monomer (Ax)]

The polymerizable monomer (Ax) is represented by the General Formula (I) in [Chemical Formula 1] below.

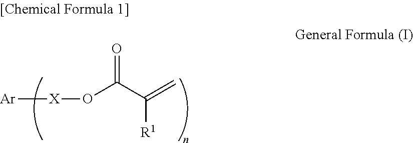

In the General Formula (I) in [Formula 1] above, Ar represents an optionally substituted divalent or trivalent aromatic group, X represents a single bond or an organic linking group, R¹ represents a hydrogen atom or an optionally substituted alkyl group, and n is 2 or 3.

In the General Formula (I) above, when n=2, Ar is a divalent aromatic group (that is, an arylene group), and when n=3, Ar is a trivalent aromatic group. Examples of the arylene group include hydrocarbon arylene groups such as a phenylene group and a naphthylene group, and heteroarylene groups for which indole, carbazole, or the like is a linking group. Hydrocarbon arylene groups are preferred. From the standpoint of viscosity and etching resistance, a phenylene group is even more preferred. The arylene group may have a substituent. Examples of preferred substituents include an alkyl group, an alkoxy group, a hydroxyl group, a cyano group, an alkoxycarbonyl group, an amido group, and a sulfonamido group.

Examples of the organic linking group represented by X include an alkylene group, an arylene group, and an aralkylene group that may contain a hetero atom in the chain. Among them, an alkylene group and an oxyalkylene group are preferred and an alkylene group is even more preferred. It is especially preferred that a single bond or an alkylene group be used as X.

R¹ is preferably a hydrogen atom or a methyl group, and more preferably a hydrogen atom. When R¹ has a substituent, the preferred substituent is not particularly limited. For example, a hydroxyl group, a halogen atom (except for fluorine), an alkoxy group, and an acyloxy group can be used. n is 2 or 3, preferably 2.

From the standpoint of decreasing the composition viscosity, it is preferred that the polymerizable monomer (Ax) be the polymerizable monomer represented by the General Formula (I-a) or General Formula (I-b) shown in [Chemical Formula 2] below.

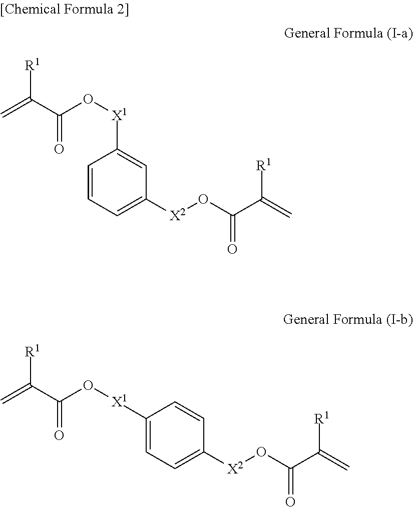

In the General Formulas (I-a) and (I-b) above, X¹, X² represent, independently from each other, alkylene groups that may have a substituent having 1 to 3 carbon atoms, and R¹ is a hydrogen atom or an optically substituted alkyl group.

In the General Formula (I-a), the aforementioned X¹ is preferably a single bond or a methylene group, and from the standpoint of reducing the viscosity, a methylene group is preferred. The preferred range of X² is similar to the preferred range of X¹.

R¹ herein has the same meaning as R¹ in the General Formula (I) above and the same preferred range. Where the polymerizable monomer (Ax) is a liquid at a temperature of 25° C., the generation of foreign matter can be advantageously inhibited even when the added amount of the monomer is increased. From the standpoint of pattern formation ability, it is preferred that the viscosity of the polymerizable monomer (Ax) at a temperature of 25° C. be less than 70 mPa·s, more preferably equal to or less than 50 mPa·s, and even more preferably equal to or less than 30 mPa·s.

Specific examples of the preferred polymerizable monomers (Ax) are shown in [Formula 3] below. R¹ herein has the same meaning as R¹ in the General Formula (I). From the standpoint of curability, a hydrogen atom is preferred as R¹.

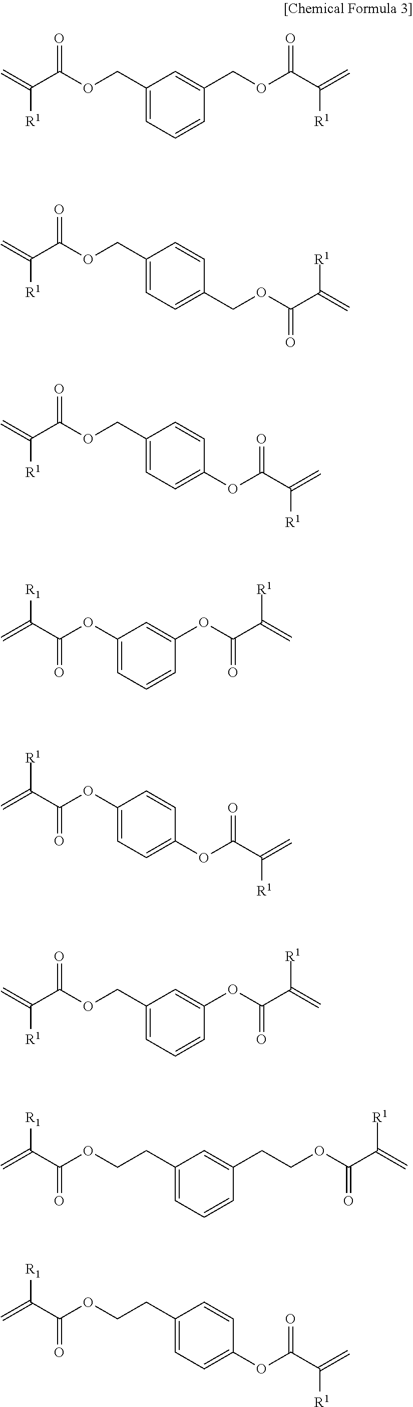

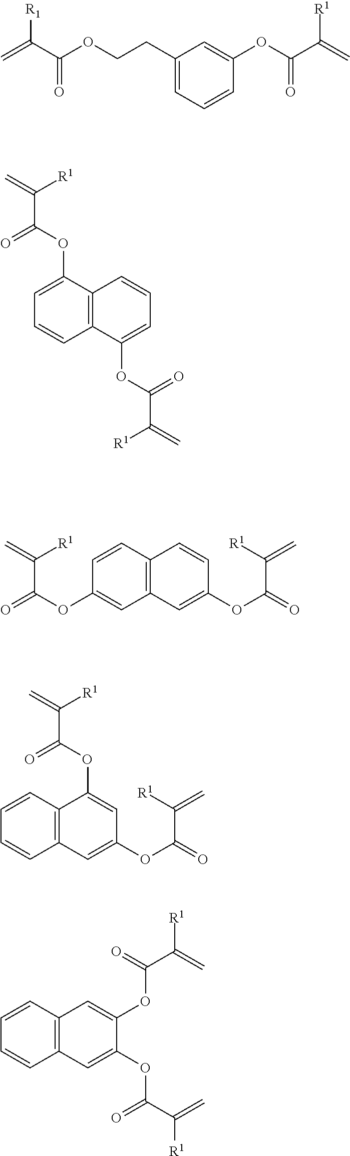

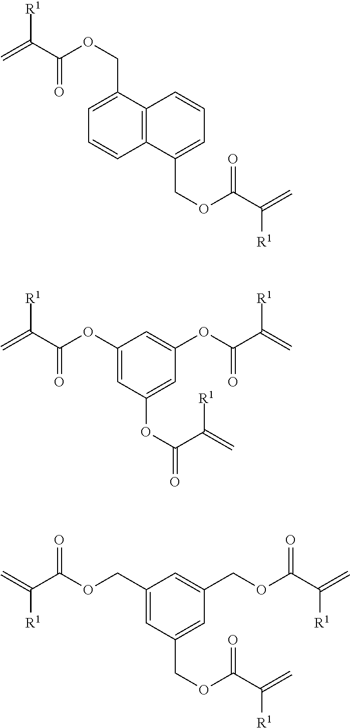

Among these compounds, the compounds shown in [Chemical Formula 4] below are especially preferred because they are liquids at a temperature of 25° C., and low viscosity and good curability can be attained.

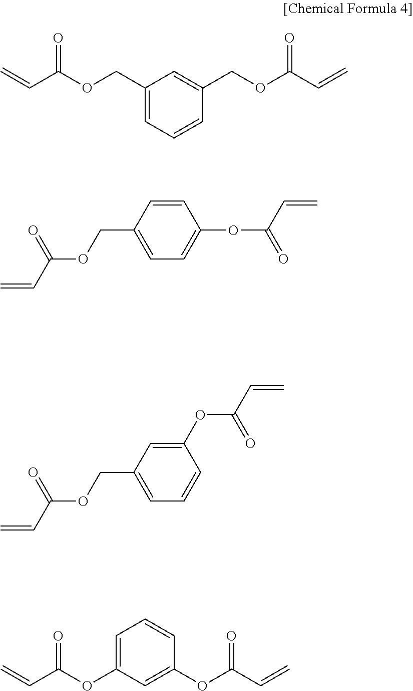

To the resist composition, from the standpoint of composition viscosity, dry etching resistance, imprint suitability, and curability, it is preferred that the polymerizable monomer (Ax) be used, as necessary, together with a below-described another polymerizable monomer that is different from the polymerizable monomer (Ax).

### [Other Polymerizable Monomers]

For example, polymerizable unsaturated monomers having 1 to 6 ethylenic unsaturated bond-containing groups; compounds (epoxy compounds) having an oxirane ring; vinyl ether compounds; styrene derivatives; compounds having a fluorine atom, and propenyl ethers or butenyl ethers can be used as the other polymerizable monomers. From the standpoint of curability, polymerizable unsaturated monomers having 1 to 6 ethylenic unsaturated bond-containing groups are preferred.

Among these other polymerizable monomers, from the standpoint of imprint suitability, dry etching resistance, curability, and viscosity, it is preferred that compounds be included that are described in paragraphs [0032] to [0053] of the description of Patent Literature 4. The aforementioned polymerizable unsaturated monomers having 1 to 6 ethylenic unsaturated bond-containing groups (mono- to hexafunctional polymerizable unsaturated monomers) that can be additionally included will be explained below.

Specific examples of polymerizable unsaturated monomers having one ethylenic unsaturated bond-containing group (monofunctional polymerizable unsaturated monomer) include 2-acryloyloxyethyl phthalate, 2-acryloyloxy-2-hydroxyethyl phthalate, 2-acryloyloxyethyl hexahydrophthalate, 2-acryloyloxypropyl phthalate, 2-ethyl-2-butylpropanediol acrylate, 2-ethylhexyl (meth)acrylate, 2-ethylhexylcarbitol (meth)acrylate, 2-hydroxybutyl (meth)acrylate, 2-hydroxyethyl (meth)acrylate, 2-hydroxypropyl (meth)acrylate, 2-methoxyethyl (meth)acrylate, 3-methoxybutyl (meth)acrylate, 4-hydroxybutyl (meth)acrylate, acrylic acid dimer, benzyl (meth)acrylate, 1- or 2-naphthyl (meth)acrylate, butanediol mono(meth)acrylate, butoxyethyl (meth)acrylate, butyl (meth)acrylate, cetyl (meth)acrylate, ethylene oxide-modified (referred to hereinbelow as “EO”) cresol (meth)acrylate, dipropylene glycol (meth)acrylate, ethoxyphenyl (meth)acrylate, ethyl (meth)acrylate, isoamyl (meth)acrylate, isobutyl (meth)acrylate, isooctyl (meth)acrylate, cyclohexyl (meth)acrylate, isobornyl (meth)acrylate, dicycloheptanyl (meth)acrylate, dicyclopentanyl oxyethyl (meth)acrylate, isomyristyl (meth)acrylate, lauryl (meth)acrylate, methoxydipropylene glycol (meth)acrylate, methoxytripropylene glycol (meth)acrylate, methoxypolyethylene glycol (meth)acrylate, methoxytriethylene glycol (meth)acrylate, methyl (meth)acrylate, neopentyl glycol benzoate (meth)acrylate, nonylphenoxypolyethylene glycol (meth)acrylate, nonylphenoxypolypropylene glycol (meth)acrylate, octyl (meth)acrylate, paracumylphenoxyethylene glycol (meth)acrylate, epichlorohydrin (referred to hereinbelow as “ECH”)-modified phenoxyacrylate, phenoxyethyl (meth)acrylate, phenoxydiethylene glycol (meth)acrylate, phenoxyhexaethylene glycol (meth)acrylate, phenoxytetraethylene glycol (meth)acrylate, polyethylene glycol (meth)acrylate, polyethylene glycol-polypropylene glycol (meth)acrylate, polypropylene glycol (meth)acrylate, stearyl (meth)acrylate, EO-modified succinic acid (meth)acrylate, tert-butyl (meth)acrylate, tribromophenyl (meth)acrylate, EO-modified tribromophenyl (meth)acrylate, tridodecyl (meth)acrylate, p-isopropenyl phenol, styrene, α-methylstyrene, and acrylonitrile.

Among these compounds, monofunctional (meth)acrylates having an aromatic structure and/or alicyclic hydrocarbon structure are preferred because they improve resistance to dry etching. Specific examples of preferred compounds include benzyl (meth)acrylate, dicyclopentanyl (meth)acrylate, dicyclopentanyl oxyethyl (meth)acrylate, isobornyl (meth)acrylate, and adamantyl (meth)acrylate, and benzyl (meth)acrylate is especially preferred.

It is also preferred that a polyfunctional polymerizable unsaturated monomer having two ethylenic unsaturated bond-containing groups be used as the other polymerizable monomer. Examples of difunctional polymerizable unsaturated monomer having two ethylenic unsaturated bond-containing groups that can be advantageously used include diethylene glycol monoethyl ether (meth)acrylate, dimethylol dicyclopentane di(meth)acrylate, di(meth)acrylated isocyanurate, 1,3-butylene glycol di(meth)acrylate, 1,4-butanediol di(meth)acrylate, EO-modified 1,6-hexanediol di(meth)acrylate, ECH-modified 1,6-hexanediol di(meth)acrylate, aryloxypolyethylene glycol acrylate, 1,9-nonanediol di(meth)acrylate, EO-modified bisphenol A di(meth)acrylate, PO-modified bisphenol A di(meth)acrylate, modified bisphenol A di(meth)acrylate, EO-modified bisphenol F di(meth)acrylate, ECH-modified hexahydrophthalic acid diacrylate, hydroxypivalic acid neopentyl glycol di(meth)acrylate, neopentyl glycol di(meth)acrylate, EO-modified neopentyl glycol diacrylate, propylene oxide (referred to hereinbelow as “PO”)-modified neopentyl glycol diacrylate, caprolactone-modified hydroxypivalic acid ester neopentyl glycol, stearic acid-modified pentaerythritol di(meth)acrylate, ECH-modified phthalic acid di(meth)acrylate, poly(ethylene glycol-tetramethylene glycol) di(meth)acrylate, poly(propylene glycol-tetramethylene glycol) di(meth)acrylate, polyester (di)acrylate, polyethylene glycol di(meth)acrylate, polypropylene glycol di(meth)acrylate, ECH-modified propylene glycol di(meth)acrylate, silicone di(meth)acrylate, triethylene glycol di(meth)acrylate, tetraethylene glycol di(meth)acrylate, dimethyloltricyclodecane di(meth)acrylate, neopentyl glycol-modified trimethylol propane di(meth)acrylate, tripropylene glycol di(meth)acrylate, EO-modified tripropylene glycol di(meth)acrylate, triglycerol di(meth)acrylate, dipropylene glycol di(meth)acrylate, divinyl ethylene urea, and divinyl propylene urea.

Among these compounds, neopentyl glycol (meth)acrylate, 1,9-nonanediol di(meth)acrylate, tripropylene glycol di(meth)acrylate, tetraethylene glycol di(meth)acrylate, hydroxypivalic acid neopentyl glycol di(meth)acrylate, and polyethylene glycol di(meth)acrylate can be particularly advantageously used in the present invention.

Specific examples of polyfunctional polymerizable unsaturated monomers having three or more ethylenic unsaturated bond-containing groups include ECH-modified glycerol tri(meth)acrylate, EO-modified glycerol tri(meth)acrylate, PO-modified glycerol tri(meth)acrylate, pentaerythritol triacrylate, EO-modified phosphoric acid triacrylate, trimethylol propane tri(meth)acrylate, caprolactone-modified trimethylol propane tri(meth)acrylate, EO-modified trimethylol propane tri(meth)acrylate, PO-modified trimethylol propane tri(meth)acrylate, tris(acryloxyethyl) isocyanurate, dipentaerythritol hexa(meth)acrylate, caprolactone-modified dipentaerythritol hexa(meth)acrylate, dipentaerythritol hydroxypenta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritol ethoxytetra(meth)acrylate, and pentaerythritol tetra(meth)acrylate.

Among these compounds, EO-modified glycerol tri(meth)acrylate, PO-modified glycerol tri(meth)acrylate, trimethylolpropane tri(meth)acrylate, EO-modified trimethylolpropane tri(meth)acrylate, PO-modified trimethylolpropane tri(meth)acrylate, dipentaerythritol hexa(meth)acrylate, pentaerythritol ethoxytetra(meth)acrylate, and pentaerythritol tetra(meth)acrylate can be particularly advantageously used in the present invention.

For example, polyglycidyl esters of polybasic acids, polyglycidyl ethers of polyhydric alcohols, polyglycidyl ethers of polyoxyalkylene glycols, polyglycidyl ethers of aromatic polyols, hydrogenated compounds of polyglycidyl ethers of aromatic polyols, urethane polyepoxy compounds, and epoxidized polybutadienes can be used as compounds (epoxy compounds) having an oxirane ring. These compounds can be used individually or in mixtures of two or more thereof.

Specific examples of the compounds (epoxy compounds) having an oxirane ring include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, hydrogenated bisphenol A diglycidyl ether, hydrogenated bisphenol F diglycidyl ether, hydrogenated bisphenol S diglycidyl ether, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ether; polyglycidyl ethers of polyether polyols obtained by adding at least one alkylene oxide to an aliphatic polyhydric alcohol such as ethylene glycol, propylene glycol, and glycerin; diglycidyl esters of aliphatic long-chain dibasic acids; monoglycidyl ethers of aliphatic higher alcohols; monoglycidyl ethers of polyether alcohols obtained by adding an alkylene oxide to phenol, cresol, butyl phenol, or mixtures thereof, and glycidyl esters of higher fatty acids.

Among these compounds, bisphenol A diglycidyl ether, bisphenol F diglycidyl ether, hydrogenated bisphenol A diglycidyl ether, hydrogenated bisphenol F diglycidyl ether, 1,4-butanediol diglycidyl ether, 1,6-hexanediol diglycidyl ether, glycerin triglycidyl ether, trimethylolpropane triglycidyl ether, neopentyl glycol diglycidyl ether, polyethylene glycol diglycidyl ether, and polypropylene glycol diglycidyl ether are preferred.

Examples of commercial products that can be advantageously used as the glycidyl group-containing compound include UVR-6216 (manufactured by Union Carbide Corp.), Glycidol, AOEX24, Cyclomer A200 (all of the above are manufactured by Daicel Chemical Industries, Ltd.), Epicoat 828, Epicoat 812, Epicoat 1031, Epicoat 872, Epicoat CT508 (all of the above are manufactured by Yuka Shell Co., Ltd.), KRM-2400, KRM-2410, KRM-2408, KRM-2490, KRM-2720, and KRM-2750 (all of the above are manufactured by Asahi Denka Kogyo K.K.). These compounds can be used individually or in combinations of two or more thereof.

The compounds having an oxirane ring can be synthesized with reference, for example, to description of Patent Literature 5 (“PTL 5”), description of Patent Literature 6 (“PTL 6”), and description of Patent Literature 7 (“PTL 7”), but manufacturing methods thereof are of no particular importance herein.

Vinyl ether compounds may be also used as the other polymerizable monomer used in accordance with the present invention. Well-known vinyl ether compounds can be selected as appropriate. Examples of such compounds include 2-ethylhexyl vinyl ether, butanediol-1,4-divinyl ether, diethylene glycol monovinyl ether, diethylene glycol monovinyl ether, ethylene glycol divinyl ether, triethylene glycol divinyl ether, 1,2-propanediol divinyl ether, 1,3-propanediol divinyl ether, 1,3-butanediol divinyl ether, 1,4-butanediol divinyl ether, tetramethylene glycol divinyl ether, neopentyl glycol divinyl ether, trimethylolpropane trivinyl ether, trimethylolethane trivinyl ether, hexanediol divinyl ether, tetraethylene glycol divinyl ether, pentaerythritol divinyl ether, pentaerythritol trivinyl ether, pentaerythritol tetravinyl ether, sorbitol tetravinyl ether, sorbitol pentavinyl ether, ethylene glycol diethylene vinyl ether, triethylene glycol diethylene vinyl ether, ethylene glycol dipropylene vinyl ether, triethylene glycol diethylene vinyl ether, trimethylolpropane triethylene vinyl ether, trimethylolpropane diethylene vinyl ether, pentaerythritol diethylene vinyl ether, pentaerythritol triethylene vinyl ether, pentaerythritol tetraethylene vinyl ether, 1,1,1-tris[4-(2-vinyloxyethoxy)phenyl]ethane, bisphenol A divinyloxyethyl ether.

These vinyl ether compounds can be synthesized by a reaction of a polyhydric alcohol or a polyhydric phenol with acetylene, or by a reaction of a polyhydric alcohol or a polyhydric phenol and a halogenated alkyl vinyl ether. These compounds can be used individually or in combinations of two or more thereof.

Styrene derivatives also can be used as the other polymerizable monomer. Examples of styrene derivatives include styrene, p-methylstyrene, p-methoxystyrene, β-methylstyrene, p-methyl-β-methylstyrene, a-methylstyrene, p-methoxy-β-methylstyrene, and p-hydroxystyrene.

A compound having a fluorine atom, such as trifluoroethyl (meth)acrylate, pentarfluoroethyl (meth)acrylate, (perfluorobutyl)ethyl (meth)acrylate, perfluorobutyl-hydroxypropyl (meth)acrylate, (perfluorohexyl)ethyl (meth)acrylate, octafluoropentyl (meth)acrylate, perfluorooctyl ethyl (meth)acrylate, and tetrafluoropropyl (meth)acrylate can be also used with the object of improving coatability and ability to separate from the mold.

A propenyl ether and a butenyl ether can be also used as the other polymerizable monomer. Examples of the propenyl ether and butenyl ether include 1-dodecyl-propenyl ether, 1-dodecyl-1-butenyl ether, 1-butenoxymethyl-2-norbornene, 1-4-di(1-butenoxy)butane, 1,10-di(1-butenoxy)decane, 1,4-di(1-butenoxymethyl)cyclohexane, diethylene glycol di(1-butenyl)ether, 1,2,3-tri(1-butenoxy)propane, and propenyl ether propylene carbonate.

### [Fluorine-Containing Surfactant]

In the imprint system shown in the present example, the fluorine-containing surfactant becomes part of the resist pattern. Therefore, it is preferred that the fluorine-containing surfactant have good resist characteristics such as good pattern forming ability, mold separation ability after curing, and etching resistance.

The content ratio of the fluorine-containing surfactant in the resist composition is for example 0.001 wt. % to 5 wt. % (not less than 0.001 wt. % and not greater than 5 wt. %), preferably 0.002 wt. % to 4 wt. % (not less than 0.002 wt. % and not greater than 4 wt. %), and more preferably 0.005 wt. % to 3 wt. % (not less than 0.005 wt. % and not greater than 3 wt. %). When two or more surfactants are used, the total amount is within the aforementioned range. Where the content ratio of the surfactant in the composition is 0.001 wt. % to 5 wt. % (not less than 0.001 wt. % and not greater than 5 wt. %), good coating uniformity is obtained and deterioration of mold transfer characteristic caused by excessive amount of surfactant or deterioration of etching adaptability in the etching step after imprinting are unlikely to be encountered.

### [Polymerization Initiator I]

The polymerization initiator I is not particularly limited and may be any compound that is activated by light L1 used when curing the resist composition and generates active species that initiate polymerization of the polymerizable compound contained in the resist composition. Radical polymerization initiators are preferred as the polymerization initiator I. In the present invention, a plurality of polymerization initiators I may be used together.

From the standpoint of curing sensitivity and absorption characteristic, acylphosphine oxide compounds and oxime ester compounds are preferred as the polymerization initiator I. For example, the compounds described in paragraph [0091] of the description of Patent Literature 10 (“PTL 10”) can be advantageously used.

The content of the polymerization initiator I in the entire composition, without the solvent, is for example 0.01 wt. % to 15 wt. % (not less than 0.01 wt. % and not greater than 15 wt. %), preferably 0.1 wt. % to 12 wt. % (not less than 0.1 wt. % and not greater than 12 wt. %), more preferably 0.2 wt. % to 7 wt. % (not less than 0.2 wt. % and not greater than 7 wt. %). When photopolymerization initiators of two or more kinds are used the sum total content thereof is within the aforementioned range.

The content of photopolymerization initiator is preferably equal to or higher than 0.01 wt. % because sensitivity (rapid curability), resolution, line edge roughness ability, and coating film strength tend to improve. On the other hand, the content of photopolymerization initiator is preferably equal to or less than 15 wt. % because light transmissivity, coloration ability and handleability tend to improve.

The preferred amounts of photopolymerization initiators added to inkjet compositions including a dye and/or a pigment or compositions for liquid crystal display color filters have been heretofore comprehensively studied, but data on the preferred amounts of photopolymerization initiators added to curable compositions for photoimprinting, such as those for imprinting, have not been published. Thus, in the systems including a dye and/or a pigment, an initiator sometimes acts as a radical trapping agent and affects photopolymerization ability and sensitivity. In these applications, the amount of the photopolymerization initiators added is optimized with consideration for this effect. By contrast, in resist compositions, dyes and/or pigments are not the mandatory components, and the optimum range of photopolymerization initiator can be different from that in the field of inkjet compositions or compositions for liquid crystal display color filters.

From the standpoint of curing sensitivity and absorption characteristic, acylphosphine oxide compounds and oxime ester compounds are preferred as the radical photopolymerization initiator included in the resist used in the imprint system shown in the present example. For example, commercial initiators can be used as the radical photopolymerization initiator used in accordance with the present invention. For example, radical photopolymerization initiator described in paragraph [0091] of the description of Patent Literature 10 can be advantageously used.

The light L1 includes light with a wavelength within range such as UV, near UV, far IR, visible, and IR and also includes radiation in addition to electromagnetic waves. The radiation is in the form of, for example, microwaves, electron beam, EUV, and X rays. Further, laser beams of a 248 nm excimer laser, 193 nm excimer laser, and 172 nm excimer laser can be used. The light may be monochromatic light (single-wavelength light) that has passed through an optical filter or light (composite light) including different wavelengths. Multiple exposure light can be used, and with the object of increasing the film strength and etching resistance, the full-surface exposure can be performed after the pattern has been formed.

The photopolymerization initiator I should be selected as appropriate with respect to the wavelength of the light source used, and it is preferred that the selected photopolymerization initiator generate no gas during mold pressing and exposure. Where gas is generated, the mold is contaminated and therefore the mold should be cleaned more frequently. Another problem is that the resist composition undergoes deformation inside the mold and degrades the accuracy of the transferred pattern.

It is preferred that the polymerizable monomer contained in the resist composition be a radical polymerizable monomer, and that the photopolymerization initiator I be a radical polymerization initiator generating radicals under light irradiation.

### [Other Components]

As has already been mentioned hereinabove, in addition to the above-described polymerizable compound, fluorine-containing surfactant, and photopolymerizable initiator I, the resist composition used in the imprint system shown in the present example may also include other components such as a surfactant, an antioxidant, a solvent, and a polymer component, within ranges in which the effect of the present invention is not lost, in order to attain the variety of objects. These other components are described in general terms below.

### [Antioxidant]

The resist composition can include a conventional antioxidant. The content of the antioxidant is for example, 0.01 wt. % to 10 wt. % (not less than 0.01 wt. % and not greater than 10 wt. %), preferably 0.2 wt. % to 5 wt. % (not less than 0.2 wt. % and not greater than 5 wt. %), on the basis of the polymerizable monomer. When two or more antioxidants are used together, the sum total of the amounts thereof is within the above-mentioned range.

The antioxidant inhibits discoloration caused by heat or light irradiation and also discoloration caused by various oxidizing gases such as active oxygen, NOₓ, and SOₓ (X is an integer). In particular, an advantage of adding an oxidant in accordance with the present invention is that coloration of the cured film can be prevented and film thickness reduction caused by decomposition can be decreased. Examples of suitable antioxidants include hydrazides, hindered amine antioxidants, nitrogen-containing heterocyclic mercapto compounds, thioether antioxidants, hindered phenol antioxidants, ascorbic acids, zinc sulfate, thiocyanic acid salts, thiourea derivatives, saccharides, nitrites, sulfites, thiosulfates, and hydroxylamine derivatives. Among them, from the standpoint of preventing coloration of the cured film and film thickness reduction, hindered phenol antioxidants and thioether antioxidants are preferred.

Examples of suitable commercial antioxidants include Irganox 1010, 1035, 1076, and 1222 (all above are manufactured by Ciba-Geigy Co.), Antigene P, 3C, FR, Sumilizer S, Sumilizer GA80 (manufactured by Sumitomo Chemical Co., Ltd.), and Adekastab AO70, AO80, and AO503 (manufactured by ADEKA). These antioxidants may be used individually or in mixtures thereof.

### [Polymerization Inhibitor]

It is preferred that the resist composition include a small amount of a polymerization inhibitor. The content ratio of the polymerization inhibitor is 0.001 wt. % to 1 wt. % (not less than 0.001 wt. % and not greater than 1 wt. %), preferably 0.005 wt. % to 0.5 wt. % (not less than 0.005 wt. % and not greater than 0.5 wt. %), and even more preferably 0.008 wt. % to 0.05 wt. % (not less than 0.008 wt. % and not greater than 0.05 wt. %), on the basis of the entire polymerizable monomer. Where the polymerization inhibitor is compounded in an adequate amount, variation of viscosity with time can be inhibited, while maintaining high curing sensitivity.

Various solvents can be included, as necessary, in the resist composition. The preferred solvent has a boiling point of 80 to 280° C. under the normal pressure. Any solvent capable of dissolving the composition can be used, but a solvent having at least one from among an ester structure, a ketone structure, a hydroxyl group, and an ether structure is preferred. Specific examples of preferred solvents include propylene glycol monomethyl ether acetate, cyclohexanone, 2-heptanone, gamma butyrolactone, propylene glycol monomethyl ether, lactic acid esters, and mixtures thereof. From the standpoint of coating uniformity, a solvent including propylene glycol monomethyl ether acetate is most preferred.

The content ratio of the solvent in the resist composition can be optimized according to the viscosity of components (without the solvent), coatability, and target film thickness, and from the standpoint of improving coatability, the content ratio of the solvent in the entire composition is from 0 wt. % to 99 wt. %, more preferably from 0 wt. % to 97 wt. %. When a pattern with a film thickness of equal to or less than 500 nm is formed, the content ratio of the solvent is preferably 20 wt. % to 99 wt. % (not less than 20 wt. % and not greater than 99 wt. %), more preferably 40 wt. % to 9 wt. % (not less than 40 wt. % and not greater than 9 wt. %), and even more preferably from 70 wt. % to 98 wt. % (not less than 70 wt. % and not greater than 98 wt. %).

### [Polymer Component]

With the object of further increasing the crosslinking density, the resist composition can include, within a range in which the object of the present invention is attained, a polyfunctional oligomer with a molecular weight even higher than the above-described polyfunctional other polymerizable monomers. Examples of polyfunctional oligomers having photoradical polymerization ability include various acrylate oligomers such as polyester acrylates, urethane acrylates, polyether acrylates, and epoxy acrylates. The amount of the oligomer component added to the resist composition is preferably 0 wt. % to 30 wt. %, more preferably 0 wt. % to 20 wt. %, even more preferably 0 wt. % to 10 wt. %, and most preferably 0 wt. % to 5 wt. %, on the basis of the composition components (without the solvent).

From the standpoint of improving dry etching resistance, imprint suitability, and curability, it is preferred that the resist composition include a polymer component. A polymer having a polymerizable functional group in a side chain is preferred as such polymer component. From the standpoint of compatibility with the polymerizable monomer, it is preferred that the weight-average molecular weight of the polymer component be 2000 to 100000, more preferably 5000 to 50000.

The amount of the polymer component is preferably 0 wt. % to 30 wt. %, more preferably 0 wt. % to 20 wt. %, even more preferably 0 wt. % to 10 wt. %, and most preferably equal to or less than 2 wt. %, with respect to the components, without the solvent, of the composition. From the standpoint of pattern formation ability, it is preferred that the content ratio of the polymer component with a molecular weight of equal to or higher than 2000 in the resist component be equal to or less than 30 wt. %, with respect to the components, without the solvent, of the composition. It is preferred that the amount of the resin component be as small as possible and that the resin component be not included at all, except for the surfactant and very small amounts of additives.

If necessary, a parting agent, a silane coupling agent, a UV absorber, a photostabilizer, an antiaging agent, a plasticizer, an adhesion enhancer, a thermopolymerization initiator, a colorant, elastomer particles, a photoacid-generating agent, a photobase-generating agent, a basic compound, a fluidity adjusting agent, an antifoaming agent, and a dispersant may be added, in addition to the above-described components, to the resist composition.

The resist composition can be prepared by mixing the above-described component. After the components have been mixed, the composition can be prepared as a solution, for example, by filtering with a filter having a pore diameter of 0.003 μm to 5.0 μm. Mixing and dissolution of curable compositions for photoimprinting is usually performed within a temperature range of 0° C. to 100° C. The filtration may be performed in multipole stages or in multiple cycles. The filtered liquid can be re-filtered. A polyethylene resin, a polypropylene resin, a fluororesin, and a Nylon resin can be used as the filter material used for filtration, but this list is not limiting.

This resist composition is adjusted in a viscosity range which enables the formation of fine droplets by an inkjet method. The range of viscosity that is ejectable by an inkjet method is from 5 mPa·s to 20 mPa·s, and desirably, from 8 mPa·s to 15 mPa·s. The amount of solvent in this case is not more than 10 weight percent. Furthermore, the viscosity increase in a case where the solvent has evaporated over time is taken to be not more than 10 mPa·s.

The surface tension of the resist composition adjusted to a viscosity which is suited to an inkjet method as described above is not less than 20 millinewton per meter and not more than 40 millinewton per meter, and desirably, not less than 25 millinewton per meter and not more than 35 millinewton per meter.

In the present embodiment, an example of a nano-imprinting system 10 comprising a photo-curable liquid ejection unit 12 and a pattern transfer unit 14 is described, but it is also possible to adopt a mode in which the photo-curable liquid ejection unit 12 and the pattern transfer unit 14 are constituted as independent apparatuses.

The pattern transfer apparatus and the pattern forming method according to the present invention can be applied suitably to a manufacturing process such as the following.

In a first technology, there are cases where the molded shape (pattern) itself has a function and can be applied as a constituent component or structural member for various nano-technologies. Possible examples are micro/nano-optical elements of various types, or structural members for high-density recording media, optical films, and flat panel displays.

In a second technology, a layered structure is built by simultaneous integrated molding of a micro structure and a nano structure, or by simple layer-on-layer positioning, and this structure is used in the manufacture of a μ-TAS (Micro-Total Analysis System) or a biochip.

In a third technology, the formed pattern is employed as a mask and used in processing a substrate by means of a method, such as etching. In this technology, by employing highly precise positioning and high levels of integration, it is possible to apply the invention to the fabrication of high-density semiconductor integrated circuits, the fabrication of liquid crystal display transistors, and the processing of magnetic bodies in next-generation hard disks, which are known as patterned media.

Moreover, the invention is also useful in the formation of micro-electrical mechanical systems (MEMS), sensor elements, and optical components, such as diffraction gratings, relay holograms, or the like, optical films or deflecting elements for fabricating nano-devices, optical devices, or flat panel displays, thin film transistors for liquid crystal displays, organic transistors, color filters, overcoating layers, columnar materials, rib materials for crystal orientation, micro lens arrays, immunity analysis chips, DNA separation chips, micro reactors, nano-bio devices, light waveguides, optical filters, photonic liquid crystals, and permanent films, such as anti-reflective structures (moth eye), and the like.

More specifically, the nano-imprinting system (apparatus) 10 relating to the present invention can adopt a composition which comprises a photo-curable liquid ejection apparatus and a pattern transfer apparatus.

A nano-imprinting system (apparatus) was described in detail above as a concrete example of a functional liquid ejection apparatus, a functional liquid ejection method and a nano-imprinting system according to the present invention, but the present invention is not limited to the aforementioned examples, and it is possible for improvements or modifications of various kinds to be implemented, within a range which does not deviate from the essence of the present invention.

### APPENDIX

As has become evident from the detailed description of the embodiments given above, the present specification includes disclosure of various technical ideas including the inventions described below.

One aspect of the invention is directed to a functional liquid ejection apparatus comprising: a liquid ejection head which includes a nozzle ejecting a functional liquid having a viscosity of not less than 5 millipascal·second and not more than 20 millipascal·second, onto a substrate, and a piezoelectric element for pressurizing the functional liquid inside a pressure chamber connected to the nozzle; a relative movement means which causes relative movement between the substrate and the liquid ejection head; a drive voltage generating means which generates a drive voltage having a pull waveform element which causes the pressure chamber to expand from a steady state and a push waveform element which causes the expanded pressure chamber to contract, with a relationship between a slope γ₁ representing voltage change per unit time in the pull waveform element when a maximum voltage is defined as 1, the viscosity η of the functional liquid, and a resonance period T_{c} of the liquid ejection head satisfying the following expression: (2/T_{c})≦γ₁≦(η/10), and a relationship between a slope γ₂ representing voltage change per unit time in the push waveform element when a maximum voltage is defined as 1, and the slope γ₁ of the pull waveform element, satisfying the following expression: γ₂≦γ₁; and an ejection head drive means which applies the generated drive voltage to the piezoelectric element so as to cause the functional liquid to be ejected from the liquid ejection head onto the substrate.

According to this aspect of the present invention, in a liquid application apparatus which ejects a functional liquid having high viscosity of not less than 5 mPa·s and not more than 20 mPa·s by pull-push driving of a piezoelectric element using a drive voltage having a pull waveform element and a push waveform element, by using a drive voltage having a slope γ₁ of the pull waveform element whereby the relationship between the resonance period T_{c} of the liquid ejection head and the viscosity η of the functional liquid satisfies (2/T_{c})≦γ₁≦(η/10), and having a slope γ₂ of the push waveform element which satisfies γ₂≦γ₁, it is possible to perform stable continuous ejection at high frequency, even if there is change in the viscosity of the functional liquid due to the evaporation of solvent or temperature change, or the like.

The “liquid having functional properties” according to this aspect of the present invention is a liquid containing a functional material which can form a fine pattern on a substrate, one example thereof being photo-curable resin liquid, such as a resist solution, or a thermo-curable resin liquid which is cured by heating.

If the unit of the resonance period T_{c} of the liquid ejection head is microseconds, the unit of the slope γ₁ of the pull waveform element and the slope γ₂ of the push waveform element is 1/microseconds, and the unit of the viscosity η of the functional liquid is mPa·s, then the coefficient 1/10 of the element of the viscosity η of the functional liquid is expressed in units of “1/nanopascal-second squared”.

Desirably, a relationship between the slope γ₂ of the push waveform element, the viscosity η of the functional liquid and the resonance period T_{c} of the liquid ejection head satisfies the following expression: (2/T_{c})≦γ₂≦(η/10).

Desirably, the drive voltage generating means generates the drive voltage having a frequency of not more than 20 kilohertz.

According to this mode, it is possible to achieve high-frequency continuous ejection at an ejection frequency of 20 kilohertz.

Desirably, an increase rate of the viscosity of the functional liquid in a state where a solvent has evaporated, is not more than 10 millipascal·second with respect to in a state before the solvent evaporates.

According to this mode, even in a state where the solvent evaporates and the viscosity increases, stable continuous ejection at high frequency is possible.

Desirably, an angle of inclination of an inclined surface linking an ejection side opening with a liquid chamber side opening of the nozzle is not less than 20 degrees with respect to a normal to a surface of the ejection side opening.

According to this mode, if the “nozzle taper angle” which is the angle of inclination between an inclined surface connecting the ejection side opening of the nozzle and the liquid chamber side opening of the nozzle, and the normal to the surface of the opening on the ejection side is not less than 20°, then the acoustic impedance of the liquid ejection head is substantially uniform and the robustness of liquid ejection is improved.

Desirably, the nozzle is formed by anisotropic etching with respect to (100) of a silicon substrate, and has a substantially square-shaped ejection side opening and a substantially square-shaped pressure chamber side opening.

In this mode, in a liquid ejection head which employs nozzles having a substantially square shape formed by applying an anisotropic etching process to a silicon substrate, it is possible to achieve stable continuous ejection of high frequency.

Desirably, the nozzle has a structure in which a relationship between a diameter D₁ of an ejection side opening and a diameter D₂ of a liquid chamber side opening satisfies the following expression: D₁>2×D₂.

In this mode, the nozzle shape may be a tapered shape (a substantially rounded conical shape).

Another aspect of the invention is directed to a functional liquid ejection method comprising: a relative movement step of causing relative movement between a liquid ejection head and a substrate, the liquid ejection head including a nozzle and a piezoelectric element, the nozzle ejecting a functional liquid having a viscosity of not less than 5 millipascal·second and not more than 20 millipascal·second onto a substrate, the piezoelectric element pressurizing the functional liquid inside the pressure chamber connected to the nozzle; a drive voltage generating step of generating a drive voltage having a pull waveform element which causes the pressure chamber to expand from a steady state and a push waveform element which causes the expanded pressure chamber to contract, wherein a relationship between a slope γ₁ representing voltage change per unit time when a maximum voltage in the pull waveform element is defined as 1, the viscosity η of the functional liquid, and a resonance period T_{c} of the liquid ejection head satisfies the following expression: (2/T_{c})≦γ₁≦(η/10), and a relationship between a slope γ₂ representing voltage change per unit time in the push waveform element when a maximum voltage is defined as 1, and the slope γ₁ of the pull waveform element, satisfies the following expression: γ₂≦γ₁; and a functional liquid application step of applying the generated drive voltage to the piezoelectric element so as to cause the functional liquid to be ejected from the liquid ejection head onto the substrate.

In this aspect of the present invention, the drive voltage generating step may adopt a mode of generating a drive voltage having a frequency of not more than 20 kilohertz.

According to this mode, it is possible to achieve high-frequency continuous ejection at an ejection frequency of 20 kilohertz.

Desirably, a relationship between the slope γ₂ of the push waveform element, the viscosity η of the functional liquid and the resonance period T_{c} of the liquid ejection head satisfies the following expression: (2/T_{c})≦γ₂≦(η/10).

Another aspect of the invention is directed to an imprinting system comprising: a liquid ejection head which includes a nozzle ejecting a functional liquid having a viscosity of not less than 5 millipascal·second and not more than 20 millipascal·second, onto a substrate, and a piezoelectric element for pressurizing the functional liquid inside a pressure chamber connected to the nozzle; a relative movement means which causes relative movement between the substrate and the liquid ejection head; a drive voltage generating means which generates a drive voltage having a pull waveform element which causes the pressure chamber to expand from a steady state and a push waveform element which causes the expanded pressure chamber to contract, with a relationship between a slope γ₁ representing voltage change per unit time in the pull waveform element when a maximum voltage is defined as 1, the viscosity 11 of the functional liquid, and a resonance period T_{c} of the liquid ejection head satisfying the following expression: (2/T_{c})≦γ₁≦(η/10), and a relationship between a slope γ₂ representing voltage change per unit time in the push waveform element when a maximum voltage is defined as 1, and the slope γ₁ of the pull waveform element satisfying: γ₂≦γ₁; an ejection head drive means which applies the generated drive voltage to the piezoelectric element so as to cause the functional liquid to be ejected from the liquid ejection head onto the substrate; and a transfer means which transfers a projection-recess pattern of a mold in which the projection-recess pattern is formed, onto a surface of the substrate onto which the functional liquid has been applied.

According to this aspect of the present invention, even if viscosity change in a functional liquid has occurred due to evaporation of the solvent or temperature change, or the like, stable continuous ejection is achieved at high frequency, and therefore a desirable layer can be formed by a functional liquid, without variation in residue, and the like.

This aspect of the present invention is especially suitable for nano-imprint lithography which forms a fine pattern at the sub-micron level. Moreover, it is also possible to form an imprinting apparatus including the respective means of the present invention.

Desirably, a relationship between the slope γ₂ of the push waveform element, the viscosity η of the functional liquid and the resonance period T_{c} of the liquid ejection head satisfies the following expression: (2/T_{c})≦γ₂≦(η/10).

Desirably, the functional liquid includes a component which produces a curing reaction based on application of energy.

Examples of a functional liquid according to this mode are a photo-curable resin liquid which produces a curing reaction by application of light energy (illumination of light) and a thermo-curable liquid which produces a curing reaction by application of thermal energy (heating).

Desirably, the functional liquid includes a photopolymerizable monomer, a photopolymerization initiator, and a solvent; and the transfer means radiates light onto the functional liquid to which the pattern has been transferred, so as to perform curing of the functional liquid.

In this mode, light of various wavelengths which produces reaction of the photopolymerizable monomer and the photopolymerization initiator can be employed. Possible examples of the light are ultraviolet light and visible light, and so on.

Desirably, the functional liquid contains a fluorine monomer.

According to this mode, it is possible to control the wettability with respect to the mold, and the functional liquid can be filled readily into the pattern formed in the mold.

Moreover, it is also possible to adjust the functional liquid to a surface tension that yields good ejection characteristics of the liquid ejection head.

Desirably, the transfer means includes: a pressing means which presses a surface of the mold in which the projection-recess pattern is formed, against the surface of the substrate onto which the liquid has been applied; a curing means which performs curing of the liquid between the mold and the substrate; and a separating means which separates the mold from the substrate.

According to this mode, a mask pattern to which the topographical pattern (projection-recess pattern) of the mold has been transferred is formed.

Desirably, the imprinting system comprises: a separating means which separates the mold from the substrate, after transfer by the transfer means; and a pattern forming means which forms a pattern corresponding to the projection-recess pattern of the mold, on the substrate, using a film formed of the liquid to which the projection-recess pattern has been transferred and curing of which has been performed, as a mask; and a removal means which removes the film.

According to this mode, a desirable sub-micron fine pattern is formed.

### REFERENCE SIGNS LIST

10 nano-imprinting system (apparatus)
12 photo-curable resin liquid application unit
14 pattern transfer unit
20 substrate
22 conveyance unit
23 nozzle
24, 24′ inkjet head
25 photo-curable resin liquid (film)
26 mold
28 ultraviolet irradiation apparatus
32 pressure chamber
38 piezoelectric element
52 system controller
60 ejection controller
61 transfer control unit
84 drive waveform generation unit
100 drive voltage (waveform)
102 pull waveform
106 push waveform

### CITATION LIST

### Patent Literature

PTL 1: Japanese Patent Application Publication No. 2009-172921
PTL 2: Japanese Patent Application Publication No. 2010-158843
PTL 3: Japanese Patent Application Publication No. 7-144410
PTL 4: Japanese Patent Application Publication No. 2009-218550
PTL 5: Japanese Patent Application Publication No. 11-100378
PTL 6: Japanese Patent No. 2906275
PTL 7: Japanese Patent No. 2926262
PTL 8: Japanese Patent Application Publication No. 2006-114882
PTL 9: Japanese Patent Application Publication No. 2008-95037
PTL 10: Japanese Patent Application Publication No. 2008-105414

1. A functional liquid ejection apparatus comprising:
a liquid ejection head which includes a nozzle ejecting a functional liquid having a viscosity of not less than 5 millipascal·second and not more than 20 millipascal·second, onto a substrate, and a piezoelectric element for pressurizing the functional liquid inside a pressure chamber connected to the nozzle;
a relative movement means which causes relative movement between the substrate and the liquid ejection head;
a drive voltage generating means which generates a drive voltage having a pull waveform element which causes the pressure chamber to expand from a steady state and a push waveform element which causes the expanded pressure chamber to contract, with a relationship between a slope γ₁ representing voltage change per unit time in the pull waveform element when a maximum voltage is defined as 1, the viscosity η of the functional liquid, and a resonance period T_{c} of the liquid ejection head satisfying the following expression:
(2/T_{c})≦γ₁≦(η/10), and
a relationship between a slope γ₂ representing voltage change per unit time in the push waveform element when a maximum voltage is defined as 1, and the slope γ₁ of the pull waveform element, satisfying the following expression:
γ₂≦γ₁; and
an ejection head drive means which applies the generated drive voltage to the piezoelectric element so as to cause the functional liquid to be ejected from the liquid ejection head onto the substrate.

2. The functional liquid ejection apparatus as defined in claim 1, wherein a relationship between the slope γ₂ of the push waveform element, the viscosity η of the functional liquid and the resonance period T_{c} of the liquid ejection head satisfies the following expression:
(2/T_{c})≦γ₂≦(η/10).

3. The functional liquid ejection apparatus as defined in claim 1, wherein the drive voltage generating means generates the drive voltage having a frequency of not more than 20 kilohertz.

4. The functional liquid ejection apparatus as defined in claim 1, wherein an increase rate of the viscosity of the functional liquid in a state where a solvent has evaporated, is not more than 10 millipascal·second with respect to in a state before the solvent evaporates.

5. The functional liquid ejection apparatus as defined in claim 1, wherein an angle of inclination of an inclined surface linking an ejection side opening with a liquid chamber side opening of the nozzle is not less than 20 degrees with respect to a normal to a surface of the ejection side opening.

6. The functional liquid ejection apparatus as defined in claim 1, wherein the nozzle is formed by anisotropic etching with respect to (100) of a silicon substrate, and has a substantially square-shaped ejection side opening and a substantially square-shaped pressure chamber side opening.

7. The functional liquid ejection apparatus as defined in claim 1, wherein the nozzle has a structure in which a relationship between a diameter D₁ of an ejection side opening and a diameter D₂ of a liquid chamber side opening satisfies the following expression:
D₁>2×D₂.

8. A functional liquid ejection method comprising:
a relative movement step of causing relative movement between a liquid ejection head and a substrate, the liquid ejection head including a nozzle and a piezoelectric element, the nozzle ejecting a functional liquid having a viscosity of not less than 5 millipascal·second and not more than 20 millipascal·second onto a substrate, the piezoelectric element pressurizing the functional liquid inside the pressure chamber connected to the nozzle;
a drive voltage generating step of generating a drive voltage having a pull waveform element which causes the pressure chamber to expand from a steady state and a push waveform element which causes the expanded pressure chamber to contract, wherein a relationship between a slope γ₁ representing voltage change per unit time when a maximum voltage in the pull waveform element is defined as 1, the viscosity η of the functional liquid, and a resonance period T_{c} of the liquid ejection head satisfies the following expression:
(2/T_{c})≦γ₁≦(η/10), and
a relationship between a slope γ₂ representing voltage change per unit time in the push waveform element when a maximum voltage is defined as 1, and the slope γ₁ of the pull waveform element, satisfies the following expression:
γ₂≦γ₁; and
a functional liquid application step of applying the generated drive voltage to the piezoelectric element so as to cause the functional liquid to be ejected from the liquid ejection head onto the substrate.

9. The functional liquid ejection method as defined in claim 8, wherein a relationship between the slope γ₂ of the push waveform element, the viscosity η of the functional liquid and the resonance period T_{c} of the liquid ejection head satisfies the following expression:
(2/T_{c})≦γ₂≦(η/10).

10. An imprinting system comprising:
a liquid ejection head which includes a nozzle ejecting a functional liquid having a viscosity of not less than 5 millipascal·second and not more than 20 millipascal·second, onto a substrate, and a piezoelectric element for pressurizing the functional liquid inside a pressure chamber connected to the nozzle;
a relative movement means which causes relative movement between the substrate and the liquid ejection head;
a drive voltage generating means which generates a drive voltage having a pull waveform element which causes the pressure chamber to expand from a steady state and a push waveform element which causes the expanded pressure chamber to contract, with a relationship between a slope γ₁ representing voltage change per unit time in the pull waveform element when a maximum voltage is defined as 1, the viscosity η of the functional liquid, and a resonance period T_{c} of the liquid ejection head satisfying the following expression:
(2/T_{c})≦γ₁≦(η/10), and
a relationship between a slope γ₂ representing voltage change per unit time in the push waveform element when a maximum voltage is defined as 1, and the slope γ₁ of the pull waveform element satisfying:
γ₂≦γ₁;
an ejection head drive means which applies the generated drive voltage to the piezoelectric element so as to cause the functional liquid to be ejected from the liquid ejection head onto the substrate; and
a transfer means which transfers a projection-recess pattern of a mold in which the projection-recess pattern is formed, onto a surface of the substrate onto which the functional liquid has been applied.

11. The imprinting system as defined in claim 10, wherein a relationship between the slope γ₂ of the push waveform element, the viscosity η of the functional liquid and the resonance period T_{c} of the liquid ejection head satisfies the following expression:
(2/T_{c})÷γ₂≦(η/10).

12. The imprinting system as defined in claim 10, wherein the functional liquid includes a component which produces a curing reaction based on application of energy.

13. The imprinting system as defined in claim 10, wherein:
the functional liquid includes a photopolymerizable monomer, a photopolymerization initiator, and a solvent; and
the transfer means radiates light onto the functional liquid to which the pattern has been transferred, so as to perform curing of the functional liquid.

14. The imprinting system as defined in claim 10, wherein the functional liquid contains a fluorine monomer.

15. The imprinting system as defined in claim 10, wherein the transfer means includes:
a pressing means which presses a surface of the mold in which the projection-recess pattern is formed, against the surface of the substrate onto which the liquid has been applied;
a curing means which performs curing of the liquid between the mold and the substrate; and
a separating means which separates the mold from the substrate.

16. The imprinting system as defined in claim 10, comprising:
a separating means which separates the mold from the substrate, after transfer by the transfer means; and
a pattern forming means which forms a pattern corresponding to the projection-recess pattern of the mold, on the substrate, using a film formed of the liquid to which the projection-recess pattern has been transferred and curing of which has been performed, as a mask; and
a removal means which removes the film.
